(19) United States
(12) Patent Application Publication
(10) Pub. No.: US 2026/0072884 A1
(43) Pub. Date: Mar. 12, 2026

(54) System-of-record (SOR) Agnostic, Multi-context, Multi-Country Ontology Based Metadata Driven Rule Enforcement Guard

(71) Applicant: ADP, INC, Roseland, NJ (US)

(72) Inventors: Bharathkumar Vaitheeswaran, Chennai (IN); Vijayanand Veeraraghavan, Chennai (IN)

(73) Assignee: ADP, INC, Roseland, NJ (US)

(21) Appl. No.: 19/325,582

(22) Filed: Sep. 11, 2025

(30) Foreign Application Priority Data
Sep. 12, 2024 (IN) 202441069042

(51) Int. Cl. G06F 16/21; G06F 9/54

(52) U.S. Cl. CPC G06F 16/212; G06F 9/544

(57) ABSTRACT

A payload including data may be received that is to be written to any of the entities included in an application database schema, where the application database schema governs storage of application data in a fluid database for a software application. A context for the payload is identified, where the context identifies an entity that is to be updated with the data in the payload. The context may include an attribute identifying a country and/or a client. Rules stored in a rule registry are searched and a set of rules is retrieved that matches the context for the payload. The rules are segregated according to context levels and are associated with the entities. The rules stored in the rule registry include logic executable to enforce the rules. The retrieved set of rules are enforced, in the payload received, by execution of the logic included in the set of rules retrieved.

This application claims priority under 35 USC § 119 to India patent application No. 202441069042, filed Sep. 12, 2024, and entitled “System-of-record (SOR) agnostic, multi-context, multi-country ontology based meta data driven rule enforcement guard.”

### TECHNICAL FIELD

This application relates to application schema and application logic enforcement and, in particular, to schema and application logic enforcement from ontologies.

### BACKGROUND

Present business application architectures suffer from a variety of drawbacks, limitations, and disadvantages. Accordingly, there is a need for inventive systems, methods, components, and apparatuses described herein.

### BRIEF DESCRIPTION OF THE DRAWINGS

The examples may be better understood with reference to the following drawings and description. The components in the figures are not necessarily to scale. Moreover, in the figures, like-referenced numerals designate corresponding parts throughout the different views.

FIG. 1 illustrates an example of a rule guard system for a software application;

FIG. 2 illustrates example components of a rule renderer and interactions between the components;

FIG. 3 illustrates example components of a rule correlator;

FIG. 4 illustrates an automated ontology generator in more detail;

FIG. 5 illustrates an example of the fields and the relationships extracted from the ontology;

FIG. 6 illustrates an example of the logic that a graph generator may employ to create a UOM graph from a UOM;

FIG. 7 illustrates the serialization of an example of a person entity portion of a UOM graph in three different formats;

FIG. 8 illustrates an example of an adaptive graph algorithm that a SOM generator may employ to create SOM(s) from a UOM graph;

FIG. 9 illustrates an example of an adaptive graph algorithm that the DOM generator may employ to create the DOM(s) from the SOM graph(s);

FIG. 10 illustrates example logic for generating the application database schema for the fluid database;

FIG. 11 illustrates example pseudo code that generates SQL statements to create the application database schema from a simple example of the DOM graph;

FIG. 12 illustrates an example of a rule in a JSON-based RDL;

FIG. 13 illustrates an example of pseudo code to segregate the DOM rules and the DOM schema;

FIG. 14 illustrates the schema portion of an example output of the pseudo code;

FIG. 15 illustrates the rule portion of an example output of the pseudo code;

FIG. 16 illustrates an example of the rule executor;

FIG. 17 illustrates an example of the rule guard system a that includes a memory and a processor; and

FIG. 18 illustrates an example flow diagram of the logic of the system.

### DETAILED DESCRIPTION

In one example, an API (application programming interface) is exposed that is configured to receive a payload and write data included in the payload to any of the entities included in an application database schema, where the application database schema governs storage of application data in a fluid database. The fluid database is an application database for a software application. A context for the payload is identified, where the context identifies an entity that is to be updated with the data in the payload. The entity is included in the entities of the application database schema. The context includes an attribute identifying a country, a client, or both. Rules stored in a rule registry are searched, and a set of rules is retrieved that matches the context for the payload. The rules stored in the rule registry are segregated according to context levels, the context levels including a universal level, a country-specific level, and a client-specific level. Each of the rules stored in the rule registry is associated with a corresponding entity in the application database schema. The rules stored in the rule registry include logic executable to enforce the rules. The retrieved set of rules are enforced, in the payload received at the API, by execution of the logic included in the set of rules retrieved.

One technical advantage of the systems and methods described below may be that the software application may operate more reliably because the rules and the application database schema may be generated from open standard ontologies, but be modified at a country-specific level and/or a client-specific level in a controlled manner. Alternatively, or in addition, a technical advantage of the systems and methods described below may be that multi-layer application logic is centrally located in the rule registry instead of being duplicated in different languages in different application layers, leading to more software defects. Alternatively, or in addition, a technical advantage of the systems and methods described below may be that application logic executes faster because the number of rules that are actually executed may be far fewer than in traditional software applications.

Alternatively, or in addition, a technical advantage of the systems and methods described below may be that the fluid database may dynamically adjust itself based on an organization's unique structure using context-sensitive rules. Instead of enforcing a rigid, one-size-fits-all schema, the fluid database adapts based on country, client, and compliance needs. Instead of applying static rules to a predefined schema, the ontology-driven system dynamically adapts schemas and validation logic, keeping business models in sync with organizational and regulatory requirements.

### Overview

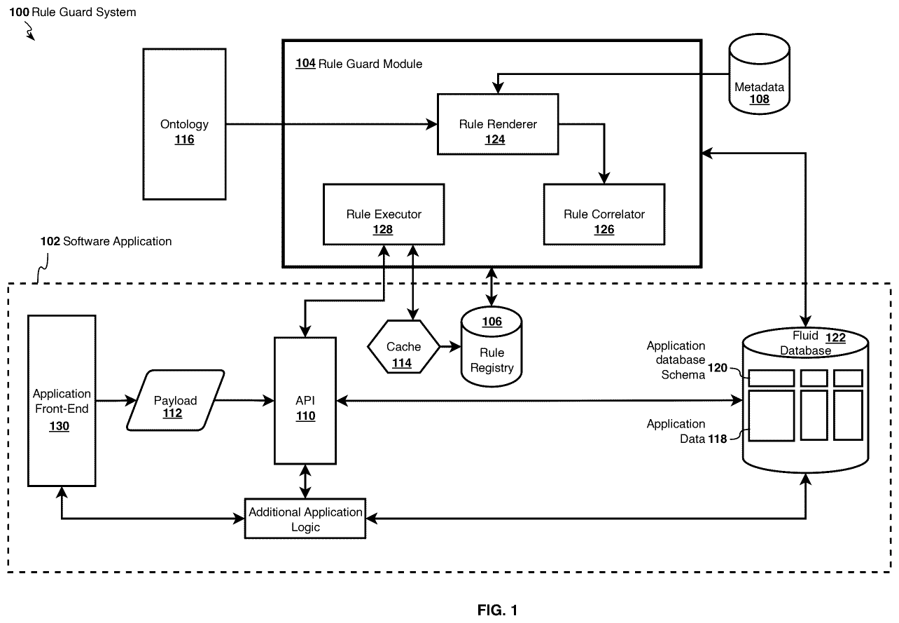

FIG. 1 illustrates an example of a rule guard system 100 for a software application 102. The system 100 may include a rule guard module 104, a rule registry 106, and metadata 108. The rule guard module 104 may include a rule renderer 124, a rule correlator 126, and a rule executor 128.

The rule guard system 100 may be a solution for the software application 102, such as a Human Capital Management system, an enterprise resource management system, a customer relationship management system, a payroll system, a human resource application, or any other type of application. The rule guard system 100 may be record neutral, meaning the software application 100 may be any type of software application and still be able to be modified to adopt the rule guard system 100.

A traditional software application may be a huge monolith, which includes legacy code. This traditional software application (“legacy software application”) may be replaced by the software application 102 that relies on the rule guard system 100. The software application 102 that relies on the rule guard system 100 may be customizable and completely or mostly driven by metadata 108 and/or ontology 116. An ontology may include a representation, formal naming, and definitions of the categories, properties, and relations between concepts, data, and/or entities within a specific domain. The ontology may be represented in a graph data structure or in some other form.

Moreover, the legacy software application may not be built for bulk operations or for highly concurrent use cases. Also, any business rules that have been defined may not be structured or organized and may have grown over the years, resulting in many duplicates and an overlapping rule set. The logic to build, expose, and run rules is highly complex and defined in numerous places, like forms, databases, and middle-tier components, and is driven by country and payroll specific overloads. Also, extracting the rules from the system has nearly become impossible because the rules may not only be scattered across the system, but also there may be huge joins required to have a complete view.

Also, in the legacy software applications, the rules may run one at a time for a request from UI, API, and imports. In addition, it may be nearly impossible for developers and product owners to keep track of business rules or their performance as response time increases exponentially. It takes a lot of country specific metadata code for developers to write and product owners to define, to solve the same problem differently. There is an overwhelming need to consolidate the rules of the legacy software application to form a holistic view, boost performance, and protect data to safeguard clients, payroll platforms, and any other type of software application from bad data. The rule guard system 100 described herein may be superior in that it may work for any type of software application. Alternatively, or in addition, the rule guard system 100 may avoid having to build business rules for every module. Alternatively, or in addition, the rule guard system 100 may greatly simplify later finding relationships with the software application 102 and/or managing changes to the software application 102.

The rule guard system 100 described herein may be a highly sophisticated system, localized, and driven by an ontology 116. In some examples, the rule guard system 100 may leverage Shapes Constraint Language (SHACL) shapes generated from the ontology 116 and the metadata 108 that addresses multiple parts and use cases. The rule guard system 100 may expose an API 110, which understands various entities in the software application 102, the entity's underlying relationships, and constraints using the rule registry 106. The API 110 may be entity agnostic, meaning that the API 110 may permit code that invokes the API 110 to specify an entity in the software application 102 to be updated. In some examples, the rule registry 106 may include, in addition to rules of the software application 102, a collection of graph structures that store client, country, and schema of the software application 102.

During operation of the rule guard system 100, the rule guard module 104 may intercept a payload 112 via the API 110 to infer the fields and properties of the payload 112 to identify, for example, applicable rules. The applicable rules may include SHACL shapes that enforce the rules when executed. The applicable rules may be cached in a cache 114 for a future request. The rule guard system 100 may smartly identify the domain related to the incoming request and extract applicable SHACL shapes through a granular field scan. The rule guard system 100 may then perform a second scan to load any relationship between related SHACL shapes, depending on the field and domain to which the payload 112 belongs. The rule guard system 100 may run the applicable SHACL shapes or, more generally, the applicable rules on the payload 112 to validate the payload 112. The validated data in the payload 112 may be stored in a fluid database 122 as application data 118 according to an application database schema 120. The fluid database 122 is an application database for the software application 102.

The solution described herein solves the complex technical problem of creating, mapping, and executing business rules, specific to the appropriate context by rendering rules from the ontology 116 and the metadata 108 related to fields and rule definitions. The rule guard system 100 may be provided with the ontology 116 from one or more open or proprietary standards, such as the HR Open Standards. However, the ontology 116 may not necessarily directly fit the needs of the software application 102 and/or the needs of every customer (client) of the software application 102. Thus, the rule guard system 100 provides an additional layer built on top of the ontology 116, which is driven by field definitions included in the metadata 108. The metadata 108 enables the ontology 116 to work in multi-context scenarios, which may be client customizable. In some examples, even product owners without having any prior coding experience, and without any developer assistance, may choose the applicable ontology, and using the field definitions, churn out rules using little effort. Developers need not know the ontology 116 or learn SHACL to build business rules. The rule renderer 124 may generate the rules from the ontology 116 and the metadata 108. In some examples, the rule correlator 126 may map and/or package a set of rules that correspond to an API or a set of forms. This seamless integration and rule consolidation may boost the accuracy and performance of the rule executor 128 when the payload 112 arrives from various input streams obtained via any type of front-end application 130. The optimized rule creation and efficient rule assignment may make the rule guard system 100 highly scalable, highly customizable, and client-centric with high-throughput and low latency.

The rule guard system 100 solves the technical problem of how to convert a data structure representing the ontology 116 into rules and the application database schema 120 that the software application 102 may utilize during execution of the software application 102. The rule guard system 100 may have an additional benefit of avoiding and/or limiting developers from having to write any code or define business rules for each domain specific API or forms. In some examples, the rule guard system 100 and, ultimately, the software application 102, may be used by only configuring the rule registry 106 and/or the metadata 108.

The rule guard system 100 may automatically define the rule types for a field through standard field definitions and may enable an administrative user to configure rules and rule sets. The ontology 116 provided to the rule guard system 100 for the software application 102 may be a standard ontology defined for the general type of application to which the software application 102 belongs. The rule guard system 100 may dynamically choose the field relationship and inherently link related forms and modules to a rule definition. This rule definition may be decorated with additional information from an existing SHACL in the rule registry 106 to create a complete validation layer for the API 110. Any system of record entity model and standard domain model may be validated through this layer before it finds itself in the fluid database 122 for use by the software application 102. Moreover, the payload 112 may be in any data exchange format, such as XML, JSON-LD, RDF Turtle, or CSV, as the rule executor 128 may normalize to the format of the payload 112 before applying the validation rules stored in the rule registry 106.

The rule guard system 100 facilitates adopting convention over configuration, thus providing an additional technical benefit that users may not have to write any computer programming code. The underlying complexity is abstracted and rules in the form of, for example, SHACL, are manufactured by defining field metadata, which also dynamically gets loaded through the ontology 116, such as a human capital management ontology.

The validation processes may be highly performant and may scale to extreme demands due to its lean nature. As an example, if the payload 112 contains a social security number as an employee identifier in the context of an employee residing in the United States, the validation performed by the rule executor 128 may run SHACL validation only for the social security number field. As another example, if the payload 112 contains a national insurance number as an employee identifier in the context of an employee residing in the United Kingdom, the rule executor 128 may run the dynamic SHACL validation for the national insurance number field alone, thus increasing the performance due to limiting what data is validated.

The fluid database 122 may change dynamically, where the application database schema 120 and/or relationships therein are modified by the rule guard system 100. Rule creation is not an afterthought; instead, rules are embedded within the ontology 116 from which domain structures may be generated. The rule registry 106 is a related flexible database, which may segregate rules into universal, country-specific, and client-specific categories. Rules may be stored in the rule registry 106, each linking contextually, enabling adaptive validation and compliance checks to be selectively applied. With hierarchical search and relevance scoring, the rule guard system 100 provides context-sensitive validation and model generation, setting a new standard in rule-driven, dynamic data processing.

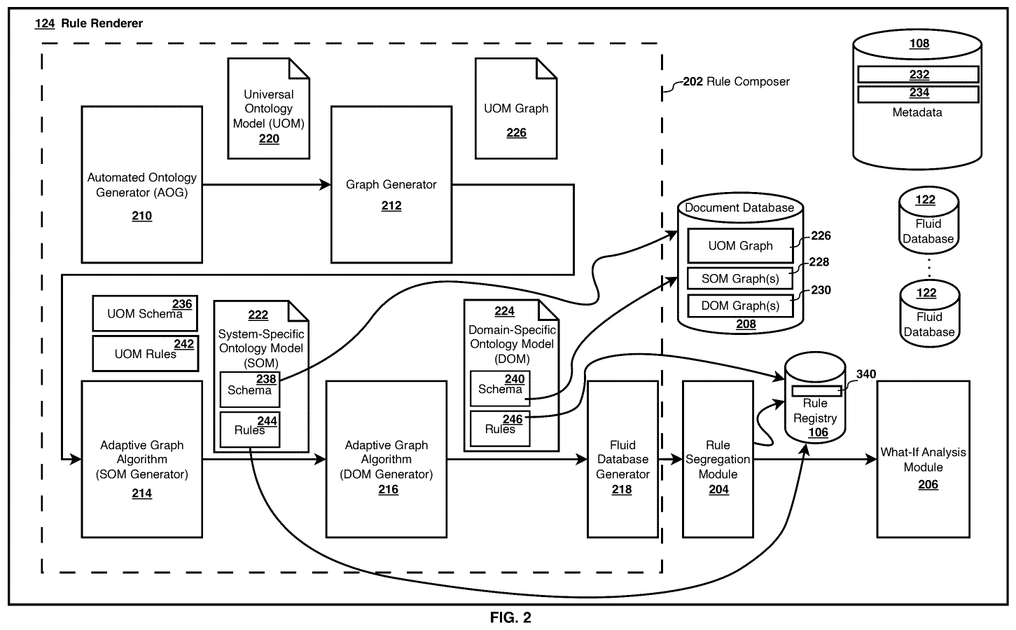

FIG. 2 illustrates example components of the rule renderer 124 and interactions between the components. In the illustrated example, the rule render 124 includes a rule composer 202, a rule segregation module 204, a what-if analysis module 206, a document database 208, the rule registry 106, the fluid database 122, and the metadata 108. The rule composer 202 may include an automated ontology generator 210, a graph generator 212, a SOM generator 214, and a fluid database generator 218.

At a high level, operation of the rule renderer 124 may begin with a Universal Ontology Model (UOM) 220, which describes a universal schema and rules for all entities. Schema, in this sense, means a description of the entities, the organization of the entities, and the relationships between the entities. Metadata 108 is provided and is used to further refine the UOM 220. In particular, by applying country-specific metadata 232 to the UOM 220, one or more country-specific (also referred to herein as system-specific) ontology models (SOMs) 222 is/are created. The SOMs 222 may be subsequently customized with client-specific metadata 234 to produce one or more domain or client-specific ontology models (DOMs) 224. Finally, the rules and the schema may be segregated into universal, country-specific, and client-specific categories, enabling precise control, compliance, and/or adaptability.

The rule composer 202 is a core part of the rule renderer 124. The rule composer 202 is designed to select relevant fields from a Universal Ontology Model (UOM) 220. The UOM 220 is a comprehensive ontology that the automated ontology generator 210 generates from, for example, the merging of an open standards ontology, any third-party ontologies, and any domain-specific ontologies related to the software application 102. As an example, the open standards ontology, the third-party ontologies, and the domain-specific ontologies related to a human capital management application may be, for example, HR Open Standards, corporate knowledge systems, and ORKG's Financial Industry Business Ontology (FIBO), respectively.

The graph generator 212 generates a UOM graph 226 from the UOM 220. The UOM graph 226 is a novel data structure in which the UOM 220 is represented in a graph data structure.

The SOM generator 214 applies an adaptive graph algorithm to the UOM graph 226 to obtain one or more System-Specific Ontology Models (SOMs) 222, narrowing the UOM 220 to entities and fields needed by the software application 102 and any customizations for the countries supported by the software application 102. The one or more SOMs 222 may be represented as one or more SOM graphs 228. The DOM generator 216 creates one or more Domain Ontology Models (DOMs) 224 for the customers of the software application 102. The DOMs 224 may be represented as one or more DOM graphs 230.

The fluid database generator 218 may generate the application database schema 120 for the software application 102 from the DOMs 224 or, in some examples, some combination of the UOM graph 226, the SOM graphs 228, and/or the DOM graphs 230. The SOM generator 214 and the DOM generator 216 may generate the rules and store the rules in the rule registry 106. The what-if analysis module 206 may provide an interactive sandbox environment to modify, create, bundle, and/or test changes to the rules and/or the application database schema 120.

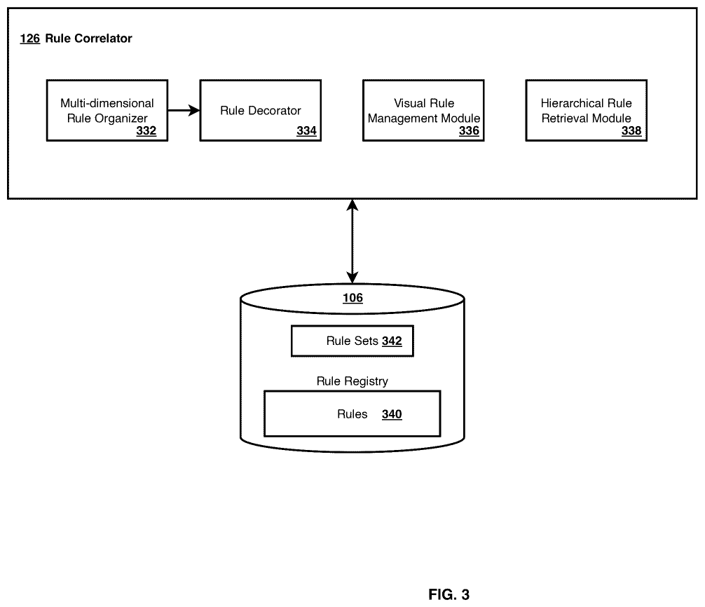

Referring again to FIG. 1, the rule correlator 126 may fine tune the output from rule renderer 124 by decorating the rules generated by the rule renderer 124. FIG. 3 illustrates example components of the rule correlator 126. In the illustrated example, the rule correlator 126 includes a multi-dimensional rule organizer 332, a rule decorator 334, a visual rule management module 336, and a hierarchical rule retrieval module 338.

The multi-dimensional rule organizer 332 categorizes the rules 340 by attributes such as universal, country, client-specific, and type (validation, transformation, or compliance). The rule decorator 234 enriches the rules 340 so that the rules 340 may be expressed in multiple programming languages. This enables the centralized rules to be applied across UI, API, or databases, where the applicable programming language may vary. For example, layered rule decoration in the rule decorator 334 enables individual or combined execution in SHACL, expression, or code layers.

A novel Rule Definition Language (RDL) is described further below. RDL enables categorization of the rules 340 by type and may facilitate organizing the rules 340 into rule sets 342. RDL may support consistent creation, documentation, and storage of the rules 340 in the rule registry 106. RDL enables a “no code” environment for developers and product owners by including rule enforcement code in the rules 340 themselves. The hierarchical rule retrieval module 338, together with RDL, enables scoped searches when finding the rules 340 applicable to incoming data. The visual rule management module 336 may create a visual management interface, provide configuration templates to simplify rule creation, and show rule interactions and overrides.

Referring to FIG. 1, the rule executor 128 may be an adaptive, multi-step engine with context-sensitive parsing and constraint enforcement, which integrates with the rule registry 106 to create a modular validation framework. This approach may enforce the context-based rules 340 refined by real-world validation outcomes, dynamically mapping the payload 112 attributes based on metadata like country and client. The rule executor 128 may apply complex logical checks while selectively skipping irrelevant fields.

Using real-time constraint enforcement, the rule executor 128 may validate the payload 112 with country-specific rules, such as enforcing a National Identification Number (NIN) in the United Kingdom and a Social Security Number in the United States, while also enforcing a people identity field as mandatory in a universal rule.

### Rule Renderer

As noted above, FIG. 2 illustrates an example of the rule renderer 124. The rule renderer 124 is for dynamically creating, adapting, and managing the application database schema 120 in the fluid database 122 and the rules 340 in the rule registry 106 based on the UOM 220. The rule renderer 124 is designed to extract entities and relationships from the UOM 220 and apply metadata 108 to generate a dynamic schema (the application database schema 120) in the fluid database 122. The rule renderer 124 may employ deterministic algorithms to generate the application database schema 120 and the rules 340. In contrast, traditional database management systems use static schemas, requiring manual updates when business needs evolve. Similarly, business rules are often defined as an afterthought, leading to inconsistencies and inefficiencies.

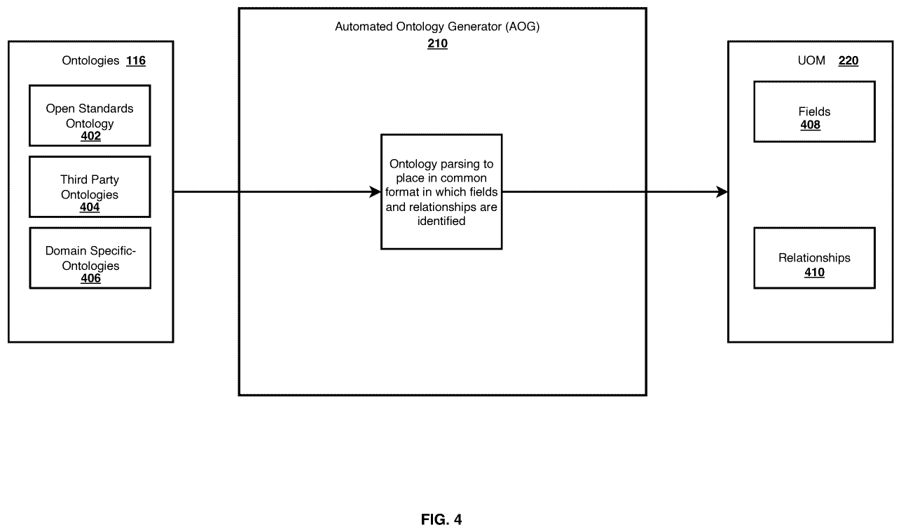

During an operation to convert the ontology 116 into the rules 340 and the application database schema 120, the rule render 124 may start with the automated ontology generator 210 generating the UOM 220 from the ontology 116. FIG. 4 illustrates the automated ontology generator 210 in more detail. The ontology 116 may include one or more different ontologies, such as an open standards ontology 402, third party ontologies 404, and/or domain specific ontologies 406. The open standards ontology 402 may be an ontology that is generic to the type of application that the software application 102 is or includes. For example, if the software application 102 is a human resource application, then the open standards ontology 402 may be an ontology for human resource applications, such as HR Open Standards. The software application 102 may interact with software applications and/or components provided by third parties. The third party ontologies 404 may include ontologies for such software applications and/or components. The software application 102 may include components that implement functionality that is not necessarily central to the software application 102. For such components, there may be corresponding ontologies. These ontologies may be referred to as the domain specific ontologies 406. An example of domain specific ontologies 406 may include ORKG's Financial Industry Business Ontology (FIBO).

How to convert the ontology 116 to the UOM 220, such that the structure and organization of the UOM 220 is useful for obtaining the rules 340, and the application database schema 120 is not at all clear. However, the automated ontology generator 210 implements an innovative algorithm for accomplishing the task of creating the UOM 220 such that the structure and organization of the UOM 220 are useful for this purpose.

The organization of the UOM 220, which the automated ontology generator 210 extracts from the ontology 116, includes a set of fields 408 and a set of relationships 410. Table 1 describes the meanings of the terms “field” and “relationship” in the context of the UOM 220. Table 1 also describes other terms for other items potentially included in the ontology 116 that will be discussed herein.

TABLE 1

| Term | Description |
|---|---|
| Entity | A distinct conceptual object, such as Person or Address. |
| Field | A specific data point within an entity (e.g., birthDate). |
| Attribute | Metadata describing a field (e.g., type, required, format). |
| Property | Dynamic traits added at runtime (e.g., isActive, |
| | createdDate). |
| Structure | The internal hierarchy of fields, types, and |
| | compositions that form an entity. |
| Relationship | A reference (e.g., $ref in a JSON schema) from one |
| | entity to another, forming a logical link. |

The terms “structure” and “relationship,” which are explained in Table 1, may require additional information to better distinguish each from the other. Table 2 provides additional information to help clarify various aspects of these two terms using a side-by-side comparison.

TABLE 2

| Aspect | Structure | Relationship |
|---|---|---|
| Description | Internal layout and composition | Logical connection between entities |
| | of an entity. | via $ref. |
| Example | birthDate, militaryStatus are part | address in Person pointing to |
| | of Person structure. | AddressType. |
| Ontology Role | Data literal in the same node. | Edge pointing to another node. |
| RDF | <Person> --birthDate--> “1980-01-01” | <Person> --address--> <Address> |
| Representation | | |
| JSON-LD | “birthDate”: “1980-01-01” | “address”: {“@id”: |
| Representation | | “http://example.org/Address/123”} |
| Cardinality | Typically, not required. | Must define (e.g., 1:1, 1:N). |
| Concern | | |

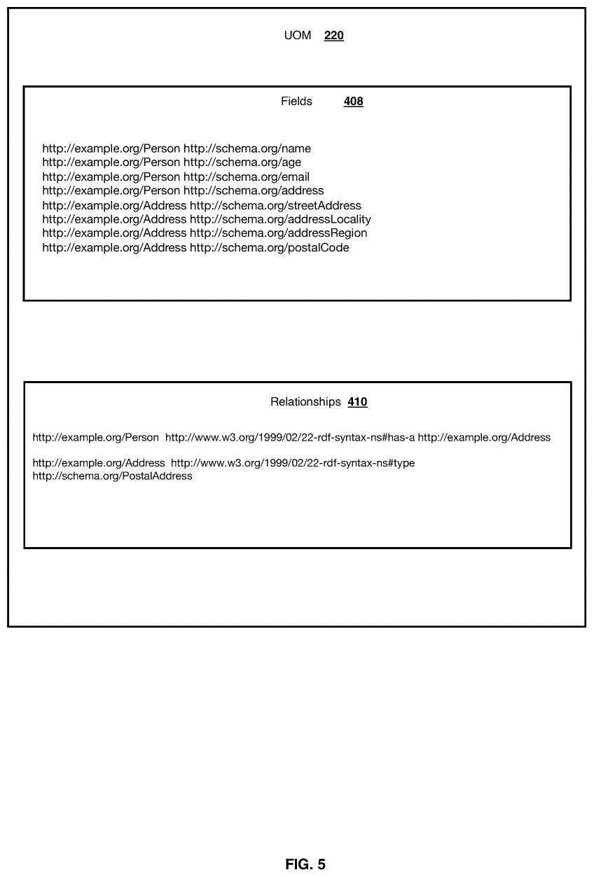

FIG. 5 illustrates an example of the fields 408 and the relationships 410 extracted from the ontology 116, where the ontology 116 includes just two relatively simple entities, namely, Person and Address. In this example, the ontology 116 and the UOM 220 are in RDF format, but any other format may be used so long as the fields 408 and the relationships 410 may be identified from the ontology 116. Accordingly, the automated ontology generator 210 may employ any script or code to parse the ontology 116 into the fields 408 and the relationships 410. The two relationships in the illustrated example are the relationship between the Address entity and its type, and the relationship between the Person entity and the Address entity.

Next in the operation to convert the ontology 116 into the rules 340 and the application database schema 120, the graph generator 212 creates the UOM graph 226 from the UOM 220. In creating the UOM graph 226 from the UOM 220, the graph generator 212 is extracting and documenting the entities in the UOM 220. The UOM graph 226 that results in a semantic graph data structure that may be exported and/or represented in a format such as RDF or JSON-LD. In connection with the description below, an example of a simplified Human Resource data exchange for People will be discussed. In this simplified example, the entities are arranged in the following example structure:
common
base
   codeList
   meta
   work
   samples
recruiting
benefits

A few of the entity related items in this example are provided in Table 3.

TABLE 3

| Item | Item Content | |
|---|---|---|
| PersonType | { | |
| Overview | “title”: “PersonType”, | |
| | “allOf”: [ | |
| | { | |
| | “$ref”: “PersonBaseType.json#” | |
| | }, | |
| | { | |
| | “$ref”: “PersonPhysicalInclusion.json#” | |
| | }, | |
| | { | |
| | “$ref”: “../profile/PersonProfileInclusion.json#” | |
| | }, | |
| | { | |
| | “$ref”: “PersonLegalInclusion.json#” | |
| | } | |
| | ] | |
| | } | |
| Per- | { | |
| sonBaseType | “birthDate”: { | |
| Fields | “$ref”: “../base/DateType.json#”, | |
| (Structure) | “description”: “The birth date of a person.” | |
| | }, | |
| | “gender”: { | |
| | “$ref”: “../codelist/GenderCodeList.json#” | |
| | }, | |
| | “address”: { | |
| | “$ref”: “../common/AddressType.json#”, | |
| | “description”: “The current address of the person.” | |
| | } | |
| | } | |
| Full | PersonType | |
| Structure | • | legalId → IdentifierType |
| of Person | • | previousLegalId → IdentifierType |
| Entity | • | birthDate → DateType |
| (Flatten) | • | gender → GenderCodeList |
| | • | citizenship[ ] → CountryCodeList |
| | • | residenceCountry[ ] → CountryCodeList |
| | • | militaryStatus : string |
| | • | ethnicity → StringTypeArray |
| | • | name → PersonNameType |
| | | ∘ given |
| | | ∘ family |
| | | ∘ alias |
| | | ∘ etc. |
| | • | address → AddressType |
| AddressType | AddressType | |
| Structure | • | addressLine1 : string |
| | • | city: string |
| | • | postalCode: string |
| | • | country → CountryCodeList |

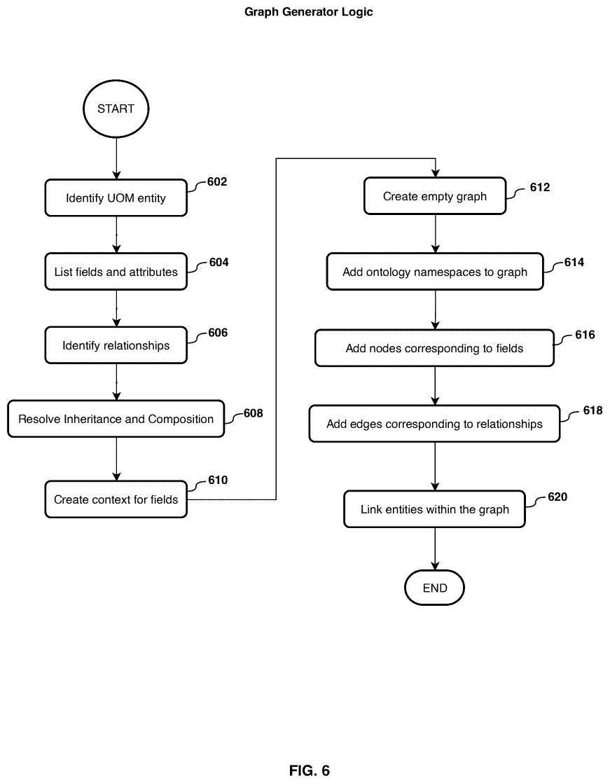

FIG. 6 illustrates an example of the logic that the graph generator 212 may employ to create the UOM graph 226 from the UOM 220. The logic may include additional, different, or fewer operations than illustrated in FIG. 6. Alternatively, or in addition, the operations may be executed in a different order than illustrated. The descriptions below of each of the operations include: (1) a sample input schema fragment, (2) corresponding pseudocode logic, and (3) a semantic output example in JSON-LD or RDF triple format, where JSON-LD and RDF represent two different example formats to represent a graph data structure.

Operations may begin by identifying (602) the entities from the UOM 220. The graph generator 212 may identify the entities by, for example, iterating over the fields 408 to determine which entities own the fields 408. Operations may then proceed by processing each of the entities.

```
    Input: the UOM 220 in a JSON file (e.g., PersonType.json) that just
has one entity
    Pseudocode:
  entity_schema = load_schema(‘PersonType.json’)
  entity_name = entity_schema.get(‘title’)
    Output: entity_name = ‘PersonType’
```

With the entity identified, the list of fields and attributes for the entity is listed (604). The fields as described in Table 1 are, in this example, “properties” of the entity in the RDF schema. The graph generator 212 extracts properties defined within the entity schema, including their types, formats, and constraints.

```
  Input: entity_schema[′properties′]
  Pseudocode:
fields = { }
    for k, v in entity_schema.get(′properties′, { }).items( ): fields[k] = {
      ′type′: v.get(′type′, ′complex′),
      ′description′: v.get(′description′, ″)
    }
  Output:
{
    ″birthDate″: { ″type″: ″string″, ″description″: ″The birth date of a
    person.″},
    ″gender″: { ″type″: ″string″, ″description″: ″Gender code.″ }
}
```

For each entity, the graph generator 212 may identify (606) the relationships with external definitions. For example, the graph generator 212 may detect $ref pointers that link to external definitions, such as another entity or codelist.

```
  Input: Look for $ref in an item of a property of an entity
  Pseudocode:
relationships = [ ]
for field, value in entity_schema.get(‘properties’, { }).items( ): if ‘$ref’
in value:
relationships.append((field, value[‘$ref’]))
  Output:
[
    [“address”, “../common/AddressType.json#”]
]
```

Next, the graph generator 212 may resolve (608) inheritance and unify the structure for the entity that includes structure inherited from other entities or composed of other entities.

```
  Input: Fields under allOf, anyOf, or oneOf
  Pseudocode:
composed = { }
for ref in entity_schema.get(‘allOf’, [ ]):
if ‘$ref’ in ref:
    sub_schema=load_schema(resolve_path(ref[‘$ref’]))
    composed.update(sub_schema.get(‘properties’, { }))
  Output: Flattened schema with merged fields from inherited base types.
```

Next, the graph generator 212 may create (610) context for fields. For example, the graph generator 212 may generate a @context block that maps schema fields to standard ontological terms like those from schema.org, FOAF (a dictionary of named properties and classes using W3C's RDF technology, or other relevant standards. For example, a context block may be used to map terms to Internationalized Resource Identifiers (IRIs) according to, for example, the JSON-LD standard.

```
  Input: Field names
  Pseudocode:
context = {k: f“schema:{k}” for k in fields.keys( )}
  Output:
{
    “@context”: {
    “birth Date”: “schema:birthDate”,
    “gender”: “schema:gender”,
    “address”: { “@id”: “schema:address”, “@type”: “@id”}
    }
}
```

Having extracted and documented the entities, the graph generator 212 may proceed to create and populate the UOM graph 226. For example, the graph generator 212 may start by initializing or creating (612) a graph structure such as an RDF graph. In this example, the graph generator 212 utilizes an RDF graph library such as rdflib to create a new graph that will house the semantic representation for the UOM graph 226.

```
  Input: None
  Pseudocode:
from rdflib import Graph
g = Graph( )
  Output: Empty graph initialized and ready to be populated.
```

Next, the graph generator 212 may add (614) ontology namespaces to the UOM graph 226. In other words, the graph generator 212 may register all relevant namespaces. The relevant namespaces may include, for example, RDF, schema, XSD, and any organization-specific URIs.

```
    Input: Ontology prefix list
    Pseudocode:
  from rdflib import Namespace
  schema = Namespace(“http://schema.org/”) g.bind(“schema”,
  schema)
    Output: Namespaces bound to graph, which, in the example, is
an RDF graph.
```

Next, the graph generator 212 may add (616) nodes corresponding to the fields of the entity to the UOM graph 226. For example, an RDF triple for each field may be added to the UOM graph 226.

Input: Literal fields from the listing (604) of fields and attributes obtained for each entity. For each atomic field (non-reference), a corresponding RDF triple may be added:
Subject=URI of the main entity
Predicate=Vocabulary term mapped from context
Object=Field value (literal or typed literal)
Pseudocode:
for each field, info in fields.items( )
g.add((entity_uri, schema [field], Literal(info [‘description’])))

Output (shown below in Turtle (Terse RDF Triple Language), a serialization format for representing RDF graphs):
<http://example.org/Person/123>schema: birthDate “1990 Jan. 1”.
<http://example.org/Person/123>schema: gender “M”.

It is understood that in adding (616) nodes corresponding to the fields of the entity to the UOM graph 226, a node corresponding to the entity containing the fields must also be added to the UOM graph 226 if the node is not already in the UOM graph 226. When a triple is added to an RDF graph for the first time using rdflib, any new subject or object in that triple becomes a node in the RDF graph. So, adding a triple both creates relationships and introduces new nodes if the nodes don't already exist in the RDF graph.

Next, the graph generator 212 may add (618) edges corresponding to the relationships of the entity to the UOM graph 226. For example, an RDF triple for each relationship may be added to the UOM graph 226.

```
    Input: Relationships identified (606) for the entity as described above
      Pseudocode:
  for field, ref_uri in relationships:
  related_uri = URIRef(“http://example.org/{field}/456”)
  g.add((entity_uri, schema[field], related_uri))
      Output (Turtle):
<http://example.org/Person/123> schema:address
<http://example.org/Address/456>
```

Operations may end, for example, with an operation to link (620), within the UOM graph 226, each entity with any other entities that the respective entity references. For example, for each $ref field: create a new URI for the referenced entity; link the URI to the starting entity using the appropriate predicate; and, optionally, expand the referenced entity's own structure recursively as was done with the starting entity. The appropriate predicate indicates the relationship between the entities within the ontology's structure. According, the appropriate predicate should be specified in the UOM 220. For example, the relationship between the entities may be explicitly specified (for example, “hasAddress”) or indicated in a standard vocabulary (for example “schema: address”), such as scheam.org, FOAF, or RDF. If no appropriate predicate is found, a new one may be added to the ontology, ensuring the ontology indicates the relationship between the entities within the ontology's structure. “Contains” may be added as the default relationship if no appropriate predicate is found.

```
  Input: Triples for nested entities
  Pseudocode:
def link_entities(parent_uri, nested_uri, predicate):
  g.add((parent_uri, schema[predicate], nested_uri))
```

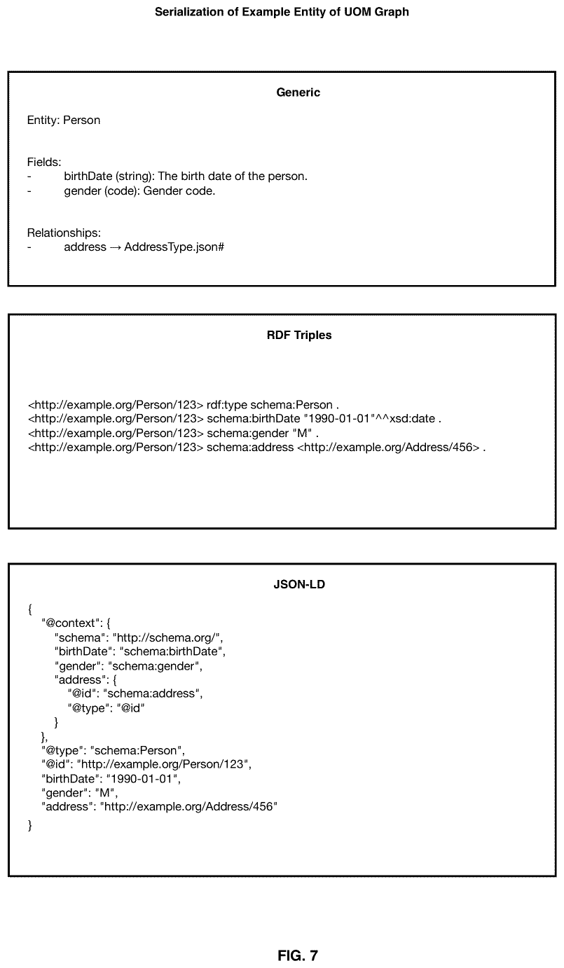

FIG. 7 illustrates the serialization of an example of a person entity portion of the UOM graph 226 in three different formats. This example is not the same as the example described in Table 3.

Referring back to FIG. 2, with the UOM graph 226 generated, the next operation in converting the ontology 116 into the rules 340 and the application database schema 120 is the creation of the SOM(s) 222 from the UOM graph 226 based on the metadata 108. The SOM generator 214 may accomplish this using the first stage of an adaptive graph algorithm. The adaptive graph algorithm enables the dynamic application of the metadata 108 in two stages: in a first stage, by applying country-specific metadata 232 to obtain the SOM(s) 222, and in a second stage, by incorporating client-specific metadata 234 to obtain the DOM(s) 224. The SOM generator 214 may perform the first stage, and the DOM generator 216 may perform the second stage.

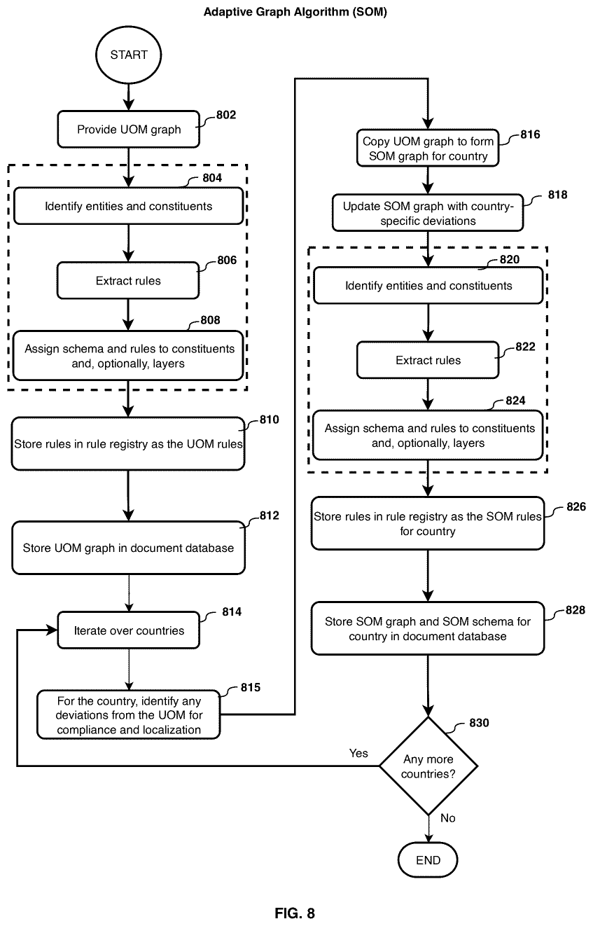

FIG. 8 illustrates an example of the adaptive graph algorithm that the SOM generator 214 may employ to create the SOM(s) 222 from the UOM graph 226. In addition, the adaptive graph algorithm identifies a UOM schema 236 to be included in the document database 208 and UOM rules 242 to be included in the rules 340 in the rule registry 106. The logic may include additional, different, or fewer operations than illustrated in FIG. 8. Alternatively, or in addition, the operations may be executed in a different order than illustrated.

In a first operation, the UOM graph 226 may be provided (802). For example, the UOM graph 226 may be generated by the graph generator 212 and/or retrieved from the document database 208.
Input: a copy of the UOM graph 226
For example, the UOM graph 226 may describe:
Entities: People, Address
Relationships: People< >Address
Rules: People.birthDate must be in the past; Address.country must be a valid ISO code.

In a second operation, the UOM graph 226 may be recursively traversed to identify (804) any constituents, sub constituents, and entities.

Input: the UOM graph 226 in an example where the UOM graph 226 includes nodes representing constituents and, in some examples, sub constituents. A constituent may be an application domain to which a set of entities belongs. For example, a constituent may be an application module of the software application 102 that groups the set of entities. In some examples, in the hierarchy of the UOM graph 226, a root node may represent a constituent, children of the constituent may represent a sub constituent, except the leaves, which may represent the entities assigned to the respective constituent and/or sub constituent under which the entities are located. When traversing nodes in the UOM graph 226, a node corresponds to an entity when the node has no parent node that represents an entity (may be a root node or have a parent node that represents a constituent or sub constituent). In some examples, the UOM graph 226 may have no sub constituents. In addition, the UOM graph 226 may have no constituents. In some examples, one or more of the constituents or sub constituents may represent a layer. The layer may include any module that may be optionally installed. Thus, the rules 340 and/or schema assigned to a layer that is not installed may be ultimately eliminated from the fluid database 122 or selectively created in the fluid database 122 when the module(s) in the layer are not installed or enabled.

For each constituent and/or sub constituent, continue to traverse the UOM graph 226 to reach the entities. Entities may have corresponding types indicated by the UOM graph 226. For example, the entities may be any of the following four types: base, codelist, meta, or a standard entity. If an entity has an “allOf” then it stands at the top and is a base entity. Alternatively, or in addition, a naming convention for entities may be used to determine if an entity is a base entity.

Consider the following example of nodes included in the UOM graph 226:
HR (constituent)
   People (entity: actual)
   Gender (entity: codelist)
Payroll (constituent)
   PayType (entity: base)
   PayCode (entity: meta)

Recursively traversing the UOM graph 226 to identify (804) any constituents, sub constituents, and entities, may result in a mapping of constituents to their assigned entities, where the entities are classified by type.

In a third operation, the UOM rules 242 may be extracted (806) from the identified entities. In examples of the UOM graph 226 that include constituents and/or layers, the UOM rules 242 and the identified entities may be associated with their assigned constituent and/or layer.

In a fourth operation, the entities identified and the UOM rules 242 extracted may be assigned (808) to the appropriate constituent and/or layer. For example, if the entity is of base type, the entity's schema and any corresponding rule may be assigned to the constituent that included the entity; if the entity is of related type, assign the entity's schema and rules to the platform layer; and for all other types, assign the entity's schema and rules to the baseline layer. If the object in the UOM graph 226 represents a relationship or contains a $ref and includes the primary entity as the subject, then the object may be considered to be “of related type.” The platform layer includes the actual entities. The baseline layer has children of actual entities. In other examples, any other suitable assignment of constituent and/or layer may be performed.

In a fifth operation, the UOM rules 242, including any assignment to constituent and/or layer, may be stored (810) in the rule registry 106. In a sixth operation, the UOM schema 236, including the identified entities and any assignment to constituent and/or layer, may be stored (812) in the document database 208.

In some examples, the software application 102 may be designed to operate in multiple countries. One or more of the countries may require deviations from, or changes to, the UOM schema 236 and/or the UOM rules 242 for the software application 102 to operate correctly in such countries. The country-specific metadata 232 may identify these changes. As explained below, the adaptive graph algorithm may create the SOM 222 corresponding to a country from the UOM graph 226 based on the country-specific metadata 232.

In a seventh operation, the SOM generator 214 may enter a loop that iterates (814) over the countries that the software application 102 is designed to support. The countries that the software application 102 is designed to support may be indicated, for example, in the country-specific metadata 232.

Operations within the loop may begin with an operation to identify (815) any deviations from the UOM graph 226 for the country selected by the loop. The deviations may be indicated in the country-specific metadata 232. The country-specific metadata 232 may have been manually populated by one or more designers who did a review of the UOM graph 226, the requirements of the software application 102, and the country-specific changes desired for the software application 102. Accordingly, identifying any deviations may include retrieving the country-specific metadata 232 to identify the entities and rules to be modified for compliance and localization. Identifying any deviations may include retrieving the country-specific metadata 232 to determine which constituents, layers, and modules are relevant for the specific country.

In some examples, the country-specific metadata 232 may be stored in tables. For example, the country-specific metadata 232 may be specified in the following tables: FIELDS, FIELDVALIDATIONRULES, LAYER, CONSTITUENT, and SUBCONSTITUENT. The contents of these tables may be limited to only those records that indicate what in the UOM graph 226 needs to be modified for each country.

For example, to identify the U.S. specific changes, the following SQL commands may be issued:
SELECT ENTITY, FIELDNAME, TYPE, ANNOTATIONS, LAYERID, CONSTITUENTID, SUBCONSTITUENTID FROM FIELDS WHERE COUNTRY=‘US’;
SELECT ENTITY, FIELDNAME, VALIDATIONTYPE, VALIDATIONEXPRESSION, REQUIRED, ERRORMESSAGEID, LAYERID, CONSTITUENTID, SUBCONSTITUENTID FROM FIELDVALIDATIONRULES WHERE COUNTRY=‘US’;
SELECT LAYERID, NAME, CONSTITUENTID, SUBCONSTITUENTID, ISENABLED FROM LAYER WHERE ISENABLED=1; (Note: in this example, layers are already in the UOM graph 226)
SELECT CONSTITUENTID, LAYERID, NAME, ISENABLED FROM CONSTITUENT WHERE ISENABLED=1;
SELECT SUBCONSTITUENTID, CONSTITUENTID, LAYERID, NAME, ISENABLED FROM SUBCONSTITUENT WHERE ISENABLED=1;

In an eighth operation, the UOM graph 226 is copied to form the country's SOM graph 228. In a ninth operation, the SOM graph 228 is updated (818) to reflect the changes indicated in the country-specific metadata 232.

In one simple example, only the following deviations from the UOM graph 226 need to be made to obtain the SOM graph 228 for the country of the United States:
Entities: People, Address
Rules: People.SSN required; Address.ZIP required.

In this simple example, the SOM graph 228 for the U.S. may be the same as the UOM graph 226 but updated to indicate that (1) the ID field for the People entity should be labeled “SSN”, (2) the ID is required, and (3) the ZIP field of the Address entity is required.

Next, as was performed in the second, third, and fourth operations of the adaptive graph algorithm described above, entities, constituents, and/or layers are identified (820), rules are extracted (822), and the schema and extracted rules are assigned (824) to constituents and, optionally, to layers, but this time with two important distinctions: (1) the operations are performed on the SOM graph 228 instead of the UOM graph 226; and (2) the operations result in creating the SOM schema 238 and the SOM rules 244 instead of the UOM graph 226 and UOM rules 242. This acts as an overwrite or override operation, ensuring that the SOM 222 and the SOM rules 244 are current and aligned with the latest copy of the metadata 108.

If, according to the country-specific metadata 232, a constituent does not need to be enabled for the country, a flag on the constituent may be set indicating the constituent is not enabled. For example, the ISEnabled flag of the constituent may be set to 0 in the SOM graph 228. Similarly, a baseline layer may be disabled at this stage if it is not required. Then, for example, only constituents and modules with ISEnabled=1 may be set to enabled in the SOM graph 228, and this selection will automatically indicate which rules are active for the country.

The SOM rules 244 may be stored (826) in the rule registry 106 for the country. This helps to ensure that the 340 rules are properly organized and may be efficiently validated and enforced within a country-specific context.

The SOM graph 228 and the SOM schema 238 may be stored (828) in the document database 208 for the country. Operations may continue to iterate (830) over the countries that the software application 102 is designed to support. Operations may end if there are no more countries to iterate over in the loop.

As a result, each country may have its own SOM graph 228 in the document database 208 and a corresponding set of SOM rules 244 in the rule registry 106. This ensures clear separation and management of country-specific ontologies and rules. In addition, enabled constituents, layers, and validation rules may be tailored to country-specific needs.

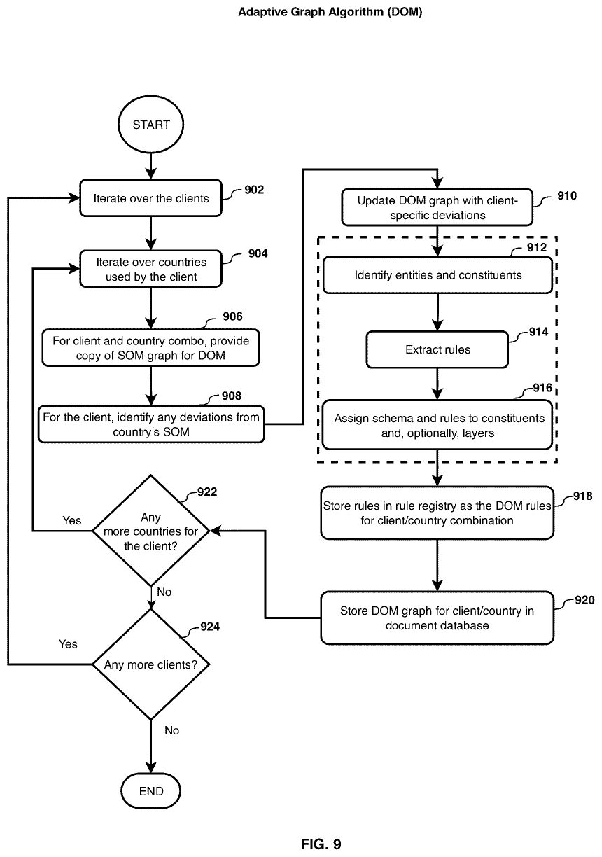

FIG. 9 illustrates an example of the adaptive graph algorithm that the DOM generator 216 may employ to create the DOM(s) 224 from the SOM graph(s) 228 based on client-specific metadata 234. The logic may include additional, different, or fewer operations than illustrated in FIG. 9. Alternatively, or in addition, the operations may be executed in a different order than illustrated.

Some clients, in other words, customers who are using/licensing the software application 102, may require customizations specific to a client, resulting in deviations from the application database schema 120 and/or the rules 340 that are specific to that client. Such deviations may be identified in the client-specific metadata 234.

How the DOM(s) 224 are created may depend on the architecture of the software application 102. The software application 102 may have a single-tenant or multi-tenant architecture. In a single tenant architecture, a single instance of the software application 102 and supporting infrastructure may serve a single customer. Alternatively, in a multi-tenant architecture, a single instance of the software application 102 and supporting infrastructure may serve multiple customers. Thus, if the software application 102 has a single-tenant architecture, then each customer may have its own instance of an application database and, therefore, its own application database schema 120. Alternatively, if the software application 102 has a multi-tenant architecture, then multiple customers may share one instance of the application database.

Similarly, the manner in which the software application 102 supports multiple countries may affect how the DOM(s) 224 are created. In some examples, the software application 102 may have a separate instance of an application database for each country, and therefore, a separate application database schema 120 for each country. Alternatively, the software application 102 may have a single instance of the application database for all the countries, and therefore, one application database schema 120 to support all the countries.

The example of the adaptive graph algorithm shown in FIG. 9 is for a single-tenant architecture having a separate instance of an application database for each combination of client and country in which the client is using the software application 102. However, it is to be understood that the adaptive graph algorithm is easily modified to support any other type of architecture or country support.

In the example of the adaptive graph algorithm shown in FIG. 9, operations may begin by entering an outer loop that iterates (902) over the clients using the software application 102. The clients may be identified in the client-specific metadata 234.

Operations may proceed by entering an inner loop that iterates (904) over the countries used by the client selected in the outer loop. The countries used by the client may be indicated in the client-specific metadata 234.

For the combination of the client and country, which are selected in the outer and inner loops, respectively, a corresponding DOM graph 230 is to be created. To start the creation of the corresponding DOM graph 230, a copy of the SOM graph 228 is provided (906). For example, the SOM graph 228 may be fetched from the document database 208.

Any deviations from the SOM graph 228 for the client may be identified (908). For example, the DOM generator 216 may fetch the client-specific metadata 234, which identifies the deviations. The client-specific metadata 234 may be in a format like the country-specific metadata 232, specifying changes to fields, validation rules, layers, constituents, and/or sub constituents.

The DOM graph 230 corresponding to the combination of client and country may be updated (910) with the changes indicated in the client-specific metadata 234.

Next, as was performed in the second, third, and fourth operations of the adaptive graph algorithm described in connection with FIG. 8, entities, constituents, and/or layers are identified (912), rules are extracted (914), and the schema and extracted rules are assigned (916) to constituents and, optionally, to layers, but this time with two important distinctions: (1) the operations are performed on the DOM graph 230 instead of the UOM graph 226; and (2) the operations result in creating the DOM schema 240 and the DOM rules 246 instead of the UOM graph 226 and UOM rules 242.

The DOM rules 246 may be stored (918) in the rule registry 106 as the DOM rules 246 for the combination of client and country. The DOM schema 240 and the DOM graph 230 may be stored (920) in the document database 208 for the combination of client and country.

The inner loop may complete (922) if there are no more countries used by the client to iterate over. The outer loop may complete (924) if there are no more clients to iterate over.

Operations may end by, for example, verifying the DOM rules 246 and the DOM schema 240, which are now separated from the DOM graph 230. This may include, for example, determining that each rule is assigned to an entity in the DOM schema 240. For example, if any of the DOM rules 246 is not assigned to any of the DOM schema 240, the unassigned rule may be flagged for exclusion.

Referring to FIG. 2, the fluid database generator 218 may generate the application database schema 120 for the software application 102 from the DOM graphs 230 or, in some examples, some combination of the UOM graph 226, the SOM graphs 228, and/or the DOM graphs 230. The application database schema 120 is a database schema for the fluid database 122. As explained further below, there may be multiple application database schemas 120 and, correspondingly, multiple fluid databases 122.

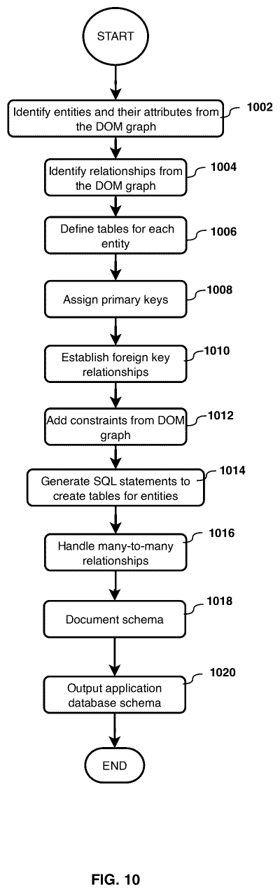

FIG. 10 illustrates an example of logic for generating the application database schema 120 for the fluid database 122. The logic may include additional, different, or fewer operations than illustrated in FIG. 10. Alternatively, or in addition, the operations may be executed in a different order than illustrated.

Operations may begin by identifying (1002) entities and their attributes in each DOM graph 230 by traversing each DOM graph 230. As a reminder, in the DOM graph 230, there are nodes that represent entities (for example, People and Address) and edges that represent relationships (for example, People↔Address). Attributes on the entity nodes may represent fields of the entities. The DOM rules 246 may indicate constraints (for example, required and/or unique) for the fields.

### Example

Nodes: People, Address
People attributes: employeeID, name, birthDate, SSN
Address attributes: officeLocation, ZIP, country

In another operation, the relationships may be identified (1004) from the DOM graph 230. For each edge, determine the type of relationship (for example, one-to-one, one-to-many, many-to-many).

### Example

People↔Address (one-to-many: one person may have multiple addresses)

Tables for each entity may be defined (1006). As an example, for each entity node in the DOM graph 230, define a table with columns for each attribute.

### Example

Table: People (employeeID, name, birthDate, SSN)
Table: Address (addressID, officeLocation, ZIP, country)

Next, assign (1008) primary keys. For example, assign a unique primary key to each table, typically an ID field.

### Example

People: employeeID (Primary Key)

Address: addressID (Primary Key)

Next, establish (1010) foreign key relationships. For each of the foreign key relationships, add a foreign key column to the definition of the referring table.

### Example

Address table gets a peopleID column as a foreign key referencing People.employeeID

Next, add (1012) constraints to columns in table definitions, where the constraints are indicated in the DOM graph 230. The constraints added to the columns may be limited to the type of constraints enforced by the type of database to be used by the fluid database 122. Examples of such constraints may include NOT NULL and UNIQUE for relational database management systems.

### Example

People.SSN: UNIQUE
Address.ZIP: NOT NULL

From the table definitions, generate (1014) SQL statements to create tables for entities. For example, SQL statements may be generated to create tables with columns, primary keys, and foreign keys. If the type of database to be used by the fluid database 122 uses a language other than SQL to create representations of entities, the commands in such a language may be generated from the table definitions.

Next, handle (1016) many-to-many relationships if there are any. For example, prepare SQL statements that create junction tables for the many-to-many relationships.

### Example

If People↔Project is many-to-many

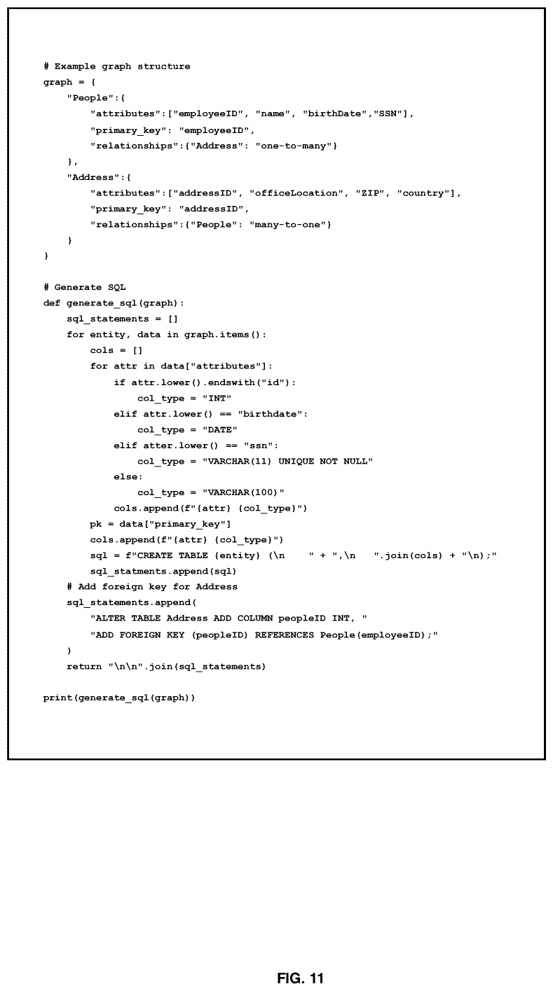

FIG. 11 illustrates example pseudo code that generates SQL statements to create the application database schema 120 from a simple example of the DOM graph 230. The graph variable holds the DOM graph 230.

Referring again to FIG. 10, operations may include documenting (1018) the application database schema 120. For example, this may include generating documentation, mapping each entity node and/or edge to a corresponding table, column, and/or relationship. This may aid, for example, an end user who is looking for a source of a table, column, and/or relationship.

### Example

People node→People table
People↔Address edge→Address.peopleID foreign key

Operations may conclude by outputting (1020) the application database schema 120. For example, one or more of the following may be generated: one or more SQL scripts that create the tables and/or an entity-relationship diagram (ERD).

In some examples, the fluid database generator 218 may execute the generated SQL script(s) against the fluid database 122, thereby creating the application database schema 120 in the fluid database 122. Because each DOM has its own application database schema 120, each application database schema 120 has its own corresponding fluid database 122 to avoid naming conflicts. Different types of databases have different meanings for “databases” and “instances.” For example, the concepts of “database” and “instance” differ between Oracle's RDBMS and Microsoft's SQL Server because they have distinct architectural models. For the purposes herein, having multiple instances of the fluid database 122 simply means that the multiple sets of application database schema 120 may be accessed individually, and the application data 118 stored in each is isolated from the others.

If the software application 102 has a single-tenant architecture and has a separate instance of the fluid database 122 for each combination of client and country in which the client is using the software application 102, then the number of DOM graphs 230 will be less than or equal to the product of the number of clients and the number of countries supported by the software application 102. In contrast, if the software application 102 has a multi-tenant architecture and each instance of the fluid database 122 supports multiple countries, then the number of DOM graphs 230 generated may depend on factors such as whether client-specific changes for one client conflict with client-specific changes for another client.

In addition, creating the application database schema 120 from each DOM graph 230 may be different in the multi-tenant architecture scenario. For example, if a country-specific change for a first country conflicts with a country-specific change for a second country, the conflict may be resolved using a mapping table.

For example, a people table may use a generic people_unique_identifier column as a universal placeholder for individual IDs. In single-tenant architectures, this column may be replaced or overridden with a country-specific identifier (for example, NIN for UK, SSN for US). In multi-tenant architectures, the column remains generic, and a mapping table may link each tenant to its relevant ID type, enabling context-aware interpretation. In single-tenant setups, the people table schema is customized for each country, replacing people_unique_identifier with a local ID like NIN (UK) or SSN (US) to simplify queries.

In a multi-tenant architecture, a single database instance serves multiple clients (tenants), each potentially operating in different countries with distinct identification standards. The people table may be designed with a generic column, “people_unique_identifier,” which stores the unique identifier for each person, regardless of the tenant's country.

### Code List Mapping Table

To resolve what “people_unique_identifier” represents for each tenant, the system 100 may use a code list (or mapping table) that associates each tenant (or country) with its specific identification type. As an example, consider the following example structure:

People Table:

| person_id | people_unique_identifier | tenant_id |
|---|---|---|
| 1 | AB123456C | UK001 |
| 2 | 123-45-6789 | US001 |
| 3 | 987654321 | IN001 |

Identifier Mapping Table:

| tenant_id | identifier_type |
|---|---|
| UK001 | National Insurance Number |
| US001 | Social Security Number |
| IN001 | Aadhaar Number |

### Rule Definition Language (RDL)

When stored in the rule registry 106, the rules 340 may be structured according to a novel rule definition language (RDL). RDL is a declarative syntax for defining and executing validation, transformation, and compliance rules in a context-aware data system. RDL may be JSON-based in some examples. RDL provides hierarchical rule segregation across universal, country-specific, and client-specific contexts. RDL provides for rule inheritance with an override option, enabling parent-child chaining of rules with context-sensitive priority. RDL may support multi-layered rule decoration (for example, SHACL for shape, expressions for logic, code for execution, and SQL). RDL may be used to define, decorate, store, and execute the rules 340 in a fluid and context-sensitive validation system.

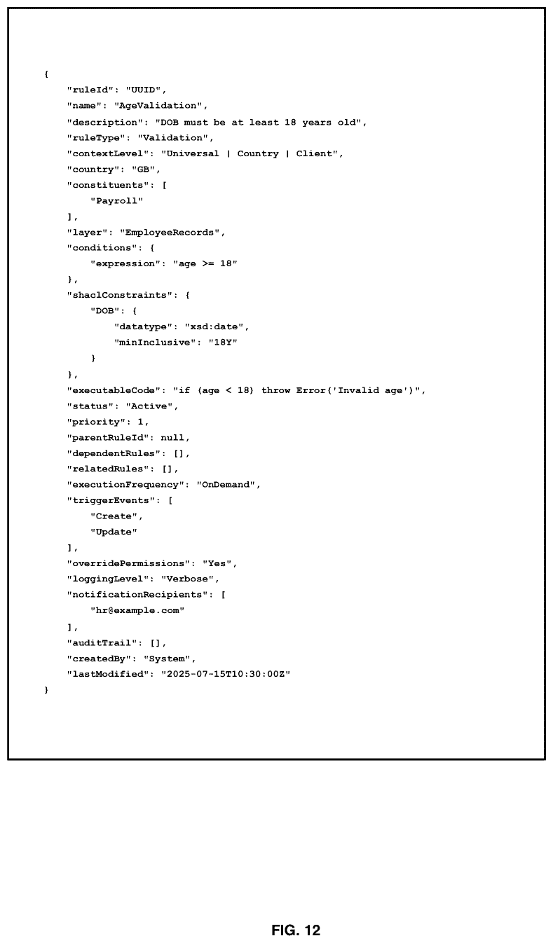

FIG. 12 illustrates an example of a rule in a JSON-based RDL. According to the RDL syntax structure, each rule in RDL is an object (such as a JSON object) and may include the following:
ruleId
name
description
ruleType: Validation|Transformation|Compliance
contextLevel: Universal|Country|Client
constituents: functional domain (e.g., Payroll)
layer: as an example, Platform|Baseline|Premium
conditions: shaclConstraints, executableCode
additional attributes: for example, priority parentRuleId, triggerEvents, etc.

Each rule may include logic to enforce the rule. In some examples, the logic may be multi-layer logic. Multi-layer logic means the same logic may be provided in multiple languages so that the logic may be executed at different layers in the software application 102. The logic in the language applicable to the respective layer is selected for execution in that layer. For example, the same logic may be provided in (1) SHACL for data shape constraints, (2) Expression, (3) Executable code for action, and (4) SQL.

The rules 340 may have a hierarchy, where the rules 340 are segregated into, and prioritized according to, the following context levels:
Universal (UOM): Global rules from standards like FIBO, HR-OS
Country (SOR): Overrides universal rules for legal and/or regional compliance
Client (DOM): Custom rules for specific client

The priority order for the context level is Client takes priority over Country, and Country takes priority over Universal. Context level divides the rules 340 based on where the rules 340 apply.

In some examples, the rules 340 may be further segregated according to constituents. The constituents represent functional domains or verticals. Each constituent may encapsulate a bounded context. Examples of constituents may include Core, Payroll, Recruitment, Leave and Attendance, Benefits, and/or any other module related to the software application 102.

Each rule belongs to a constituent and may have a rule type. Examples of the rule type include Validation, Transformation, and Compliance. A validation rule type may perform data integrity checks (for example, age>=18). A transformation validation rule type may modify or compute field values (for example, GrossPay=Base +Bonus). A compliance rule type may be for regulatory adherence (for example, SSN format).

In some examples, the rules 340 may be further segregated according to layers. The layers may represent a logical layer within a constituent. In some examples, the layers may represent install and/or license related packages available for the software application 102. Each constituent has layers of increasing complexity. Examples of layers may include Platform (basic or minimum functional rules), Baseline (standard features), Premium (advanced and/or custom logic). Platform may represent a bare minimum required to execute. Baseline may represent standard rules. Premium may represent advanced and/or custom extensions. Each rule may belong to one constituent and one layer, simplifying execution targeting and traceability. Layers may reduce rule-loading complexity by scoping execution based on constituent layers.

In some examples, the rules 340 may be further segregated according to field and/or purpose. The rules 340 may be grouped by target entity and/or target purpose. For example: AGE18-Age check, EMAILFORMAT-Email regex, and NIN-GB-National Insurance Number for GB.

The rules 340 may be further segregated by version number tag. For example, in the name of the rule, a version number may be appended, such as _001, _002, and so on. The latest version may be selected as the currently effective rule.

The rules 340 may be further segregated by an override tag. The rules 340 may support inheritance and/or overriding in the object-oriented design sense. Inheritance and overriding support enables logic reuse, controlled overrides, and/or traceability across context level (Universal→Country→Client). The rules 340 may inherit via parentRuleId field. For example, a client-specific rule for ACME Corporation may inherit from a country-specific rule for Great Britian where the client-specific rule has the properties “ruleld”: “RULE-AGE-ACME”, “parentRuleId”: “RULE-AGE-GB”, and “contextLevel”: “Client”. Overriding may be accomplished via decoration. For example, a rule may have an override tag that acts as a decorator, indicating explicitly that the rule is to override its parent rule. The override tag may be appended to the name of the rule.

Table 4 summarizes various dimensions of rule segregation supported by RDL.

TABLE 4

| Dimension | Example/Purpose |
|---|---|
| Context Level | UOM/SOR/DOM |
| Constituent | Core, Payroll, Recruitment |
| Layer | Platform, Baseline, Premium |
| Rule Type | Validation, Transformation, Compliance |
| Field/Purpose | AGE18, EMAIL, EMAILFORMAT, SNN |
| Version & Override | _001, _Y/_N for overrides |

The rules 340 may follow a rule naming convention.

### Example Format:

<Domain>_<ContextLevel/Country>_<Constituent>_<Layer>_<Purpos e/Field>_<Condition/Detail>_<RuleType>_<Version>_<Override>

### Example Rule Names:

HR_DOM_ACME_PAYROLL_PREMIUM_EMAILFORMAT_VALIDATI ON_002_Y
HR_DOM_ACME_PAYROLL_PREMIUM_OVERTIMECALC_COMPLI ANCE_003_Y
HR-DE-PAYROLL-PLATFORM-VALIDATION-AGE18-001-N
HR_UOM_CORE_BASELINE_NAME_REQUIRED_VALIDATION_001_N
HR_SOR_DE_PAYROLL_PLATFORM_AGE18_VALIDATION_001_Y
HR_DOM_ADP_PAYROLL_PREMIUM_EMAILFORMAT_VALIDATIO N_002_Y

If no client-specific rule is present, the rule falls back to the country-specific rule, and finally back to the universal rule.

Table 5 provides a summary of various elements of RDL.

TABLE 5

| Element | Description |
|---|---|
| Syntax | JSON-based DSL with SHACL, expressions, |
| | and code layers |
| Rule Segregation | Universal → Country → Client, with |
| | override precedence |
| Constituent Rule | Grouped by business domain, e.g., Payroll |
| Layer Rule | Scoped within constituent: Platform, |
| | Baseline, Premium |
| Country/Client | Country ensures compliance, client offers |
| Rule | customization |
| JSON Schema | Defines full metadata, constraints, logic, |
| | and traceability |

### Rule Segregation

Referring back to FIG. 2, with the application database schema 120 created, the next operation in converting the ontology 116 into the rules 340 is the segregation of the rules 340. The rule segregation module 204 may segregate the rules 340 in the example illustrated in FIG. 2.

The rule segregation module 204 may start with the DOM(s) 224. In a single-tenant architecture, each DOM 224 will have a corresponding document database in the rule registry 106. In a multi-tenant architecture, each DOM 224 will have its own collection within a document database in the rule registry 106.

At this point, the DOM schema 240 and the DOM rules 246 have already been created for each DOM 224. In the examples described above, the DOM schema 240 and the DOM rules 246 are comprehensive in that they include all universal, country-specific, and client-specific schema and rules intermixed with each other. The rule segregation module 204 may segregate the DOM schema 240 and the DOM rules 246 into separate structures for universal, country-specific, and client-specific schema and rules.

For each of the DOMs 224, four operations may be performed.

In a first operation, separate structures for universal, country-specific, and client-specific schemas and rules may be created.

In a second operation, the DOM schema 240 may be segregated into the three separate structures for the universal, country-specific, and client-specific schema. For example, for each field in the DOM schema 240: (1) if the field has country-specific information, classify the field under the country-specific schema; (2) if the field is client-specific, classify the field under the client-specific schema; or (3) otherwise, classify the field under the universal schema.

In a third operation, the DOM rules 246 may be segregated into the three separate structures for the universal, country-specific, and client-specific schema. For example, for each rule in the DOM rules 246: (1) if the rule has country-specific information, classify the rule under the country-specific rules; (2) if the rule is client-specific, classify the rule under the client-specific rules; or (3) otherwise, classify the rule under the universal rules.

As a result, the DOM rules 246 are segregated into universal, country-specific, and client-specific structures, ensuring modularity and clear separation of concerns. In addition, the DOM schema 240 is segregated into universal, country-specific, and client-specific structures.

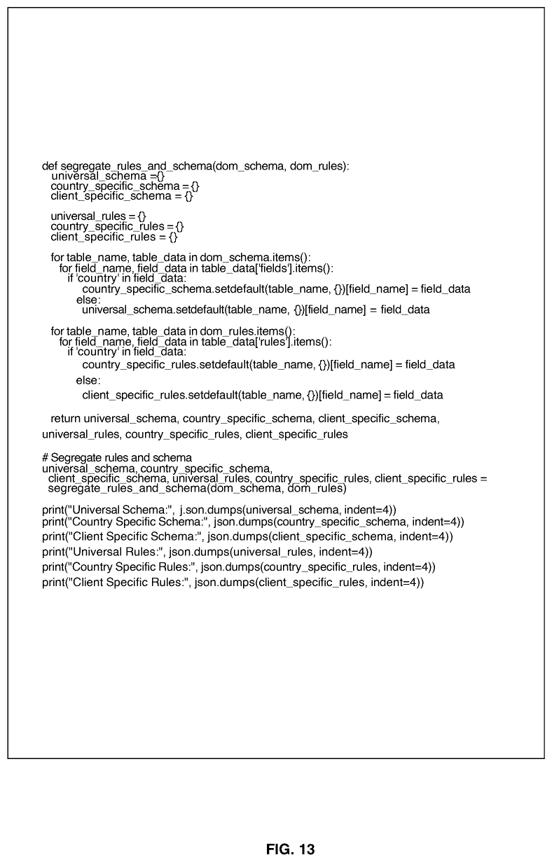

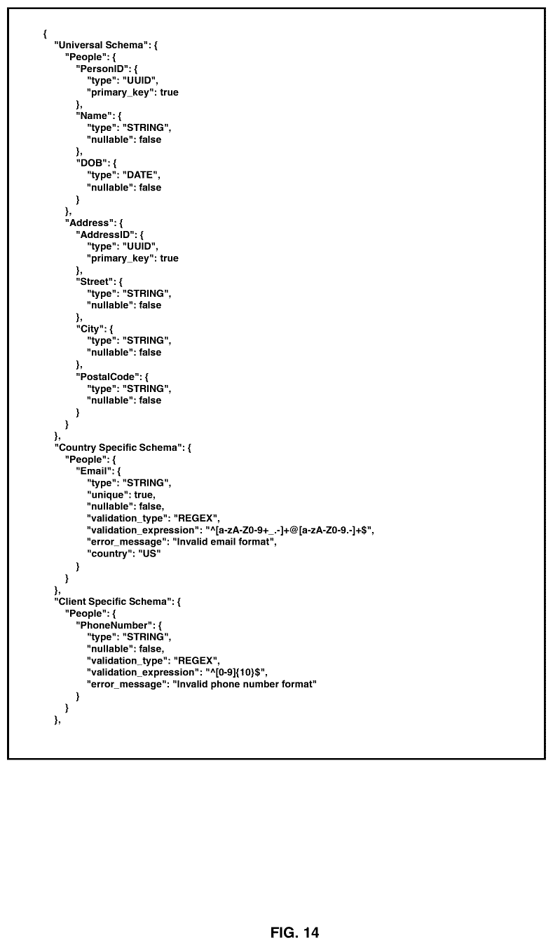

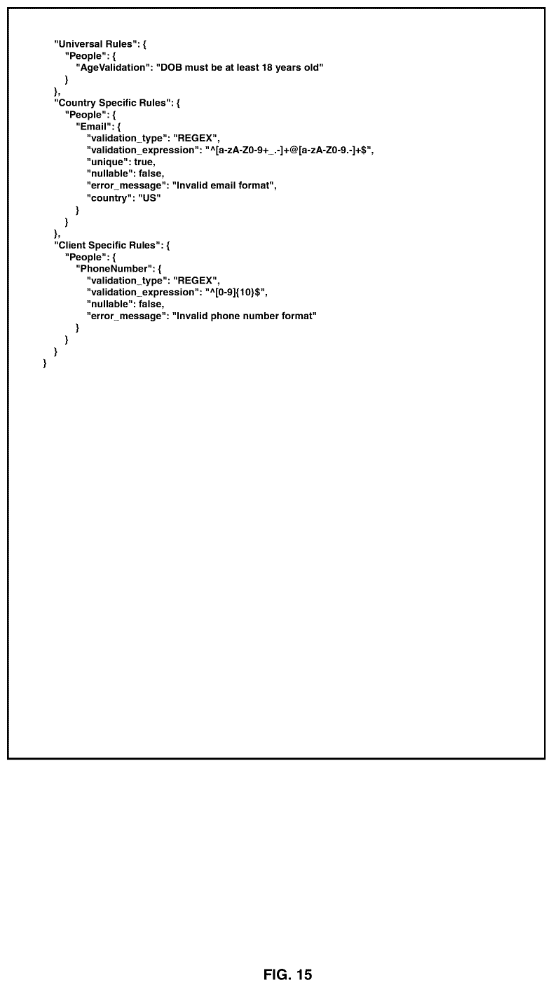

FIG. 13 illustrates an example of pseudo code to segregate the DOM rules 246 and the DOM schema 240. FIG. 14 illustrates the schema portion of an example output of the pseudo code. FIG. 15 illustrates the rule portion of an example output of the pseudo code.

At this stage, the rule registry 106 is created along with the fluid database 122. While the schema is final, the rules 340 are not yet final, even though the rules 340 have been categorized and segregated. Only after the rule correlator 126 decorates the rules will the rules be final.

Referring again to FIG. 2, the what-if-analysis module 206 may provide an Interactive Sandbox Environment that enables users to test ontology modifications and rule applications interactively. Before applying structural changes, users may interact with the sandbox via a graphical user interface to ensure that new relationships do not introduce conflicts. Users may interact with the Interactive Sandbox Environment (ISE) by, for example, dragging and dropping fields from the UOM to construct the SOM schema 238 and/or the DOM schema 240. Users may further classify rules and schema as country-specific, creating a country constituent for country-specific requirements. Client-specific fields or rules may be added to the DOM 224. Client constituents may be created for segregating client-specific rules. Sub constituents may also be created via the graphical user interface.

Alternatively, or in addition, the metadata 108 may control which constituents, sub constituents, entities, and/or fields are enabled in the SOM(s) 222 and/or DOM(s) 224. A user may enable or disable constituents, sub constituents, entities, and/or fields by adjusting the country-specific metadata 232 and/or the client-specific metadata 234. For example, if Address is not needed for a country, then the country-specific metadata 232 may set a flag on the Address entity to indicate the Address is disabled. If all of the UOM 220 is required and is not changed in any country or for any client, the metadata 108 may be empty. If the country-specific metadata 232 or client-specific metadata does not specify any rules for an entity, the entity may be either marked as disabled or the entry deleted.

If all of the UOM 220 is required and is not changed in any country or for any client, the metadata 108 may not have any entries. While this is not likely at the outset, it represents a desirable end state. Ultimately, all variations in schema and rules may be incorporated into the UOM, with only minor overrides available in the SOM(s) 222 and/or DOM(s) 224.

The what-if-analysis module 206 may include a “what-if” analyzer that enables users to check if the rules 340, the UOM schema 236, and/or the SOM schema(s) 238 are suitable for universal or country constituents. If non-compliance or errors are detected, a deployment may fail, prompting users to resolve the issues. The what-if-analysis module 206 may predict the effect of introducing new relationships, nodes, or rules. For example, if a new public holiday is introduced, it should automatically align with HR policies without requiring a manual schema update. As another example, if a company mandates at least one correspondence address for payroll processing, the rule guard system 100 may enforce this rule clearly for applicable employees. The rule guard system 100 also may maintain version control, enabling rollback and audits for compliance.

### Rule Correlator

Referring to FIG. 3, after the rule renderer 124 has created the rules 340 in the rule registry 106, the rule correlator 126 may finalize the rules 340 with the multi-dimensional rule organizer 332 and the rule decorator 334. The multi-dimensional rule organizer 332 categorizes the rules 340 by attributes such as universal, country, client-specific, and type (validation, transformation, or compliance). Each rule may be tagged to indicate whether the rule is for validation, transformation, or compliance.

The rule decorator 334 enriches or decorates the rules 340 by expressing logic in the rules 340 in multiple programming languages. Examples of programming languages may include SHACL shapes, expressions, code (for example, C, C++, C#, or python), and SQL commands. Having the logic expressed in multiple languages makes the rules 340 versatile and adaptable for various processing needs. For example, the same rule may be executed at the user interface layer, at the API layer, and/or at the database layer, thus avoiding duplication of logic across various layers of code and/or incorrect implementation or maintenance as a result. Instead, the logic is concentrated in the rule.

In some examples, the rule decorator 334 may decorate a rule differently depending on the rule. For example, the rule for employee tax calculation may be in a universal rule by default and include its logic as executable code, with specific overrides for the country also being expressed as executable code. In contrast, a salary cap rule, which ensures salary is within a permissible range, may be available as a SHACL shape or an expression. The rule decorator 334 may also tag the rules 340 to specify an application layer in which the rules 340 need to execute. The application layer may include, for example, a user interface (UI), an import tool, the API 110, a browser, or any combination of these application layers or environments. This grouping may form a rule type, such as a “people rule type.” A collection of rule types may form a rule set, which may be grouped by country or constituent.

In some examples, the logic in the rules 340 may be generated in one programming language by automatically converting the logic already written in another programming language. For example, if the People.employeeID is indicated as being mandatory, then a SHACL constraint, C# code, and an expression implementing that common constraint may be automatically populated into the rule. Alternatively, or in addition, the logic in a programming language may be manually written.

The visual rule management module 336 displays how the rules 340 interact and which rule overrides others within a specific context. Here, “context” refers to context level (universal, country, or client-specific). Configuration templates may enable users of the visual rule management module 336 to apply code or expression to rules within template, quickly creating complex rules without coding from scratch. Users may visually drag and drop the rules 340 to start defining SHACL constraints, expressions, or writing code or SQL triggers, or any combination of these through the visual rule management module 336. The visual rule management module 336 may also provide a user-friendly configuration template to fill out forms instead of using drag and drop, offering a no-code or low-code environment. After the code or decoration is completed, users may filter and retrieve rules by country or constituent. If the same rule, such as “a person should be 18 years of age,” exists as a universal rule and as a country rule with a different requirement (e.g., 21 years), the prioritized hierarchy will give precedence to the country rule and ignore the universal rule. Users may also inherit rules for reuse and then customize them as needed. The rules 340 that are created may be stored in the rule registry 106.

The rules 340 may be grouped into rule sets 342. For example, an “Employee Compliance Set” rule set may contain rules for eligibility, department, assignment, and contract requirements, each defined as a validation rule under this set, while an “Employee Department Type” rule set may contain only department related requirements, in other words, a subset of the “Employee Compliance Set” rule set.

The hierarchical rule retrieval module 338 is a search engine configured to perform scoped searches in the rule registry 106 and dynamic filtering. The hierarchical rule retrieval module 338 executes hierarchical searches and enables rule indexing. Rule indexing provides a novel way to retrieve rules by context, such as country and constituent. The hierarchical rule retrieval module 338 organizes the rules 340 that are retrieved into a prioritized hierarchy based on specificity, enabling efficient rule discovery and application based on user-defined criteria.

In order to search the rule registry 106, the hierarchical rule retrieval module 338 may first determine a document database within the rule registry 106 and/or a collection within the document database that corresponds to the context. For example, in the single-tenant application example described above, the hierarchical rule retrieval module 338 may build a connection string based on the combination of the country identifier and the client identifier included in the context.

The hierarchical rule retrieval module 338 may apply multi-dimensional rule filtering when performing searches. Multi-dimensional rule filtering filters dynamically based on one or more attributes, such as country identifier, client identifier, constituent, sub constituent, and/or layer indicating context. Contextual priority resolution prioritizes rules based on a hierarchical structure; for example, a country-specific rule takes precedence over a universal rule. This prioritized resolution system allows for seamless overrides, ensuring that the most relevant rules are applied without manual intervention. Dynamic rule composition and inheritance enable rule inheritance.

Consider an example of a query for rules being made to the hierarchical rule retrieval module 338 with specific parameters: Country=Germany and Constituents=Payroll. The hierarchical rule retrieval module 338 filters through the rules based on the input context. The hierarchical rule retrieval module 338 finds: (1) A general payroll rule applicable to all countries and industries; (2) A client-specific rule that applies only to this client; and (3) A German healthcare rule that applies specifically to all-sized organizations in Germany. Because multiple rules match the context, the hierarchical rule retrieval module 338 applies a hierarchical prioritization. Specifically, the hierarchical rule retrieval module 338 uses a priority hierarchy: (1) country-specific overrides (takes precedence over) universal rules; (2) client-specific rules override country payroll rules; and (3) layer is considered (if a rule is not directly attached to the client but to a layer such as platform or baseline and the layer is enabled). The hierarchical rule retrieval module 338 selects the Germany-specific payroll rule for payroll calculation, overriding broader rules.

If a rule at a particular context level is missing (in other words, not found), then the next lower context level rule is sought. For example, if no specific rule for the country “Germany” exists, then the hierarchical rule retrieval module 338 searches the next lower context level, such as a universal payroll rule.

In some examples, the hierarchical rule retrieval module 338 may log the query and resolution path, providing traceability for compliance audits and feedback.

The rules 340 may be well-organized and in complete alignment with the schema, enabling developers and product owners to quickly spin up APIs, forms, and imports. It is seamless to view how many forms a rule type or set is assigned to, and how many rule types form a rule set.

### Rule Executor

Referring to FIG. 1, the rule executor 128 may implement a rule execution validation process that is highly adaptable and provides multi-step validation with context-sensitive parsing, adaptive validation, and constraint enforcement. The rule executor 128 integrates the rule registry 106 with a validation mechanism to create a modular and intelligent payload validation framework. This framework enables the rules 340 in the rule registry 106 to be enforced in a contextual way and be refined based on real world data validation outcomes. The dynamic parsing and context sensitive payload mapping maps attributes of the payload 112 that is incoming to fields in the rules 340 based on contextual metadata such as country and rule type. This may include flexible data type parsing, enabling the rule executor 128 to handle diverse formats. The rule executor 128 may invoke the hierarchical rule retrieval module 338 of the rule correlator 126 to retrieve any rules 340 that are applicable to the payload 112. Each rule retrieved may be layered with adaptable constraints using an adaptive validation layer. SHACL shapes, for example, may validate structure, while embedded code may perform a complex logical check; and if certain fields are irrelevant, rules governing those fields may be skipped. Every validation may be available in various formats, and validation technology may be used to compile the same rules in various formats.

In real-time constraint enforcement, the rule executor 128 may validate each payload 112, pulling constraints from the rule registry 106. For example, a United Kingdom based healthcare rule may enforce a pay-as-you-earn income tax calculation, while a similar rule specific to the Netherlands may enforce a progressive income tax. In another example, a drop-down menu for a leave type selectable in a user interface of the software application 102 may contain context-specific values and constraints that may accompany the payload 112. Self-optimizing validation patterns logs validation outcomes, tracking frequent failures, using a feedback loop, the executor adapts validation patterns for future payloads. The rule executor 128 may use rule execution modes-real-time, delayed, and conditional, based on validation outcome.

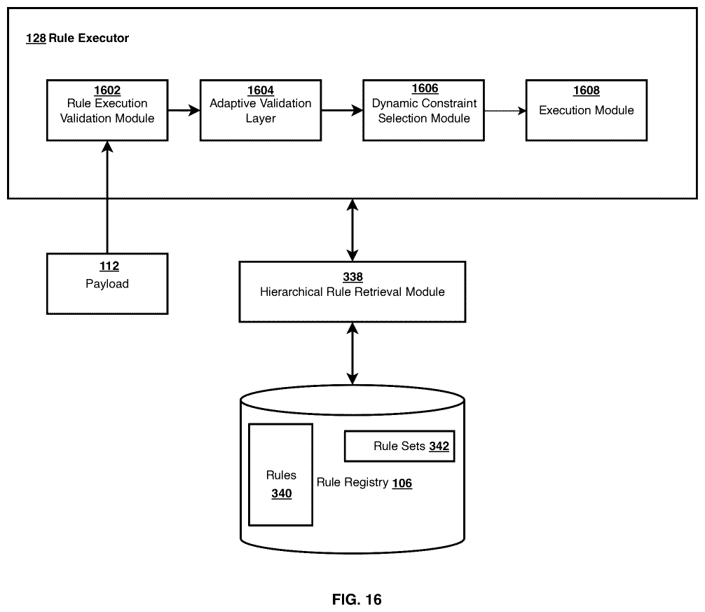

FIG. 16 illustrates an example of the rule executor 128. The rule executor 128 in the illustrated example includes a rule execution validation module 1602, an adaptive validation layer 1604, a dynamic constraint selection module 1606, and an execution module 1608. The operation of these components is described below.

The rule execution validation module 1602 may validate structural integrity, data linkage, and logical consistency of the payload 112. When the payload 112 arrives from the front-end application 130, the API 110 may provide the payload 112 to the rule executor 128 for processing. Processing may begin with the rule execution validation module 1602. The rule execution may start with context-sensitive parsing. Context-sensitive parsing includes identifying the context of the payload 112. For example, identifying the context may include identifying any entity identifiers that identify an entity that is to be updated with the data in the payload 112. In some examples, the entity to be updated may be derived from the field name of an identifier specified in the payload 112. As an example, a field name of PEOPLE_ID may indicate that the PEOPLE entity is being updated, and the field identifying the PEOPLE being updated is PEOPLE_ID. In some examples, a form used to send the payload 112 may be identified in the payload 112 with a form identifier. There may be one or more rule sets 342 that are assigned to the form, so the context may include the form identifier.

Identifying the context may further include identifying one or more indications of the dimensions listed in Table 4, such as context level, constituent, layer, and rule type. For example, there may be a country field in the payload 112 that identifies the country, which provides an indication of the context level (in this example, country) of the incoming data.

The rule execution validation module 1602 may normalize the payload 112 into a flat structure (for example, from a JSON object to flat). For example, a JSON file or document may be created that just includes fields and their respective data. As an example, the names of the fields in the flat structure may also include the entity name, such as people.firstname, people.lastname, people.address.firstline, and so on. Any hierarchy is indicated by the field name in the flat structure.

Next, the rule execution validation module 1602 may perform a field scan on the flat structure to identify the specific fields having incoming data, such as the “firstname” field of the “people” entity. This field slicing effectively drills down to identify the specific fields having incoming data. The context, the flat structure (or the data included therein), and the identified fields may be provided by the rule execution validation module 1602 to the adaptive validation layer 1604.

The adaptive validation layer 1604 may retrieve the rules 340 from the rule registry 106 by requesting the hierarchical rule retrieval module 338 to retrieve the rules 340 that are relevant. The adaptive validation layer 1604 may provide the entity identifiers and the context to the hierarchical rule retrieval module 338 to retrieve the rules 340 that may be relevant.

The dynamic constraint selection module 1606 may process the rules 340 that are retrieved from the rule registry 106. In some examples, the dynamic constraint selection module 1606 may limit the rules 340 retrieved to those applicable to a source of the payload 112. For example, the source of the payload 112 may be indicated as a database, a third-party invocation of the API 110, or the front-end application 130, such as an import tool or a graphical user interface. Based on the source of the payload 112 (for example, UI, API, or database), the dynamic constraint selection module 1606 may limit the rules 340 retrieved to the rules 340 applicable to the source of the payload 112.

Once the relevant rules are available, the execution module 1608 applies the relevant rules to the payload 112. The execution module 1608 performs context-sensitive adaptation, which helps to ensure that no extra rules are executed. Context-sensitive adaptation may include: (1) a structural integrity verification, (2) expression application, (3) code execution, and/or (4) context-sensitive rule skipping.

(1) Structural Integrity Verification: Verify that the incoming flat structure (for example, a JSON document) is properly structured. The structural integrity of the payload may be verified using any of the relevant rules decorated with SHACL shapes.

(2) Expression Application: Any of the relevant rules decorated with expressions may be applied to the payload 112 if being called from an application layer that supports expressions, such as the UI. The expressions may be executed at the UI, for example, if the UI directly invokes the rule executor 128 instead of sending the payload 112 to the API 110.

(3) Code Execution: Any of the relevant rules decorated with code may be executed if the rule executor 128 is invoked from an application layer that supports the execution thereof.

(4) Context-Sensitive Rule Skipping: Other rules may be skipped if a more context-sensitive rule is already available. This context-sensitive rule skipping is inherent to the design of RDL and the hierarchical rule retrieval module 338, which limits the applicable rules to the appropriate context (country, client, constituent, and so on). In addition, by limiting the incoming fields to just the fields to be updated, the rules 340 retrieved and/or executed may be further limited to the rules 340 that are applicable to the fields present in the payload 112 that is incoming.

Finally, the execution module 1608 rule executor 128 returns a pass/fail response.

An example of the rule executor 128 processing the payload 112 is provided below. Table 6 provides an example of a rule that the rule executor 128 retrieves in this example. The rule is a Payroll Calculation for Germany at the Platform Layer.

TABLE 6

| Attribute | Value |
|---|---|
| Rule ID | PAYROLL-DE-PLATFORM |
| Name | German Payroll Calculation |
| Description | Calculates payroll considering German |
| | country regulations |
| Rule Type | Compliance |
| Context Level | Country, Platform |
| Country | Germany |
| Industry | Healthcare |
| Organization Type | Medium |
| Parent Rule ID | PAYROLL-DE-GENERAL |
| Dependent Rules | TAX-CALCULATION-DE, BENEFITS-DE |
| Priority | 1 |
| Conditions | IF Country == “Germany” |
| Expression | GrossPay = BaseSalary + Overtime − Deductions |
| SHACL Constraints | {baseSalary: >=0, overtimeHours: >=0} |
| Executable Code | Python or another scripting language |
| | for inline execution |
| Status | Active |
| Activation Date | 2024-01-01 |
| Expiry Date | None |
| Execution Frequency | Monthly |
| Logging Level | Verbose |
| Notification Recipients | HR Compliance, Payroll Admin |

### Parent Rule and Inheritance:

This rule inherits from a parent rule, PAYROLL-DE-GENERAL, which applies to all sectors in Germany. The inheritance allows this healthcare-specific rule to override general conditions where necessary, while still applying rules that are general German regulations if the rules are not overridden here.

### Conditions and Expressions:

The Conditions field specifies when this rule should be triggered, based on country, layer and constituent.

The Expression field provides a formula for payroll calculation, customized to include allowances or deductions specific to the client.

### SHACL Constraints:

This ensures data validation, where baseSalary must be a non-negative number, and overtimeHours must be zero or positive, as per regulatory constraints in Germany.

### Dependency Management:

This rule has dependencies on TAX-CALCULATION-DE and BENEFITS-DE. These dependencies indicate that the payroll calculation only occurs after tax and benefit calculations are complete, maintaining a logical sequence and accuracy of the calculations set forth in the decorations.

### Logging and Notification:

The rule indicates that each application of the rule is to be logged. This results in creating a record for compliance audits.

Specified recipients (none in this example) may be notified if any unusual values or errors arise during execution, keeping, for example, HR and payroll teams informed.

### Executable Code:

The rule includes code for execution, enabling the rule to directly implement formulas or computations. This feature supports dynamic calculations and transformations without requiring additional scripting outside of the rules 340.

In this example, when a client purchases the product that contains the Payroll constituent, payroll itself provides various layers. Here, a platform layer constitutes bare minimum logic to perform payroll, while a baseline layer has premium features. Rule creators have the flexibility to add rules to specific layers, as was done in this example (in other words, the “Platform” constituent). Assigning a rule to a layer and constituent reduces the number of rules loaded during execution of the rule executor 128.

### Adaptive Validation Layer

Payroll processing rule for payload in Germany. In this example, the incoming payload 112 includes fields such as employeeID, baseSalary, overtimeHours, and healthInsuranceNumber.

Context: A client is submitting data in Germany, which is a country that has specific compliance requirements for payroll.

### Relevant Validation Layers:

SHACL Layer: Confirms that mandatory fields like employeeID and baseSalary are present and validates data types.

JSON-LD Layer: Maps employeeID to an entity reference (EMPLOYEE) for identification purposes, ensuring accurate data linkage.

Logical Layer (Code): Verifies that baseSalary meets Germany's minimum wage and calculates allowable deductions based on employee type.

### Validation Process:

The adaptive validation layer 1604 receives the payload 112 and selects relevant validation constraints from the rules 340 that are retrieved based on the context.

For payroll in Germany, adaptive validation layer 1604 applies strict validation for healthInsuranceNumber and baseSalary compliance with wage standards.

The SHACL validation confirms that all mandatory fields (employeeID, baseSalary) are present, and types are correct.

Any missing fields are flagged for correction, ensuring data completeness before proceeding.

JSON-LD links employeeID to the appropriate entity in the system for record-keeping and verifying relationships without checking unrelated fields.

A logical Layer verifies compliance with German wage standards by executing the executable code expressed in the rule.

If baseSalary is below the minimum wage, this layer may trigger a high-priority warning or error, marking the data as non-compliant and ready for corrective action.

### Dynamic Constraint Selection

### Contextual Metadata Extraction:

As the payload 112 arrives, the rule execution validation module 1602 first gathers metadata, such as:
Country: Germany (DE)
Source: Api/UI/Imports
Constituent/Layer: Payroll & Platform

This metadata is used to identify which regulations apply to the data, narrowing the scope of the rules 340 that are applicable.

### Rule Registry Lookup:

The rule executor 128 queries the rule registry 106 via the hierarchical rule retrieval module 338, which includes rules tagged by context, such as country codes, industry, and organization size (client-specific rules). Some relevant rules may include:
Rule R1: Minimum wage compliance (Germany)
Rule R2: Health insurance verification (Germany, Healthcare)
Rule R3: Overtime compensation calculation
Rule R4: Department compliance check for healthcare (Germany)

### Relevance Scoring:

Based on context, each rule is assigned a relevance score to prioritize essential validations:
Rule R1: Minimum wage compliance has a high score since it is critical in Germany.
Rule R2: Health insurance verification also scores high because it is industry specific.
Rule R3: Overtime compensation has a medium score because it's relevant for organizations with non-standard work hours.
Rule R4: Department compliance has a low score; it's less critical for payroll and may be processed later.

### Constraint Filtering:

Based on the relevance scores, only Rules R1, R2, and R3 are selected for immediate application, while Rule R4 is deferred to be executed later.

### Sequential Validation by Constraint Type:

Structural Constraints (SHACL): Verify the existence and data type of baseSalary and healthInsuranceNumber.

Linkage Constraints (JSON-LD): Ensure employeeID references an existing entry in the organization's database.

Logical Constraints (Code-based Rules): The rule executor 128 executes R1, R2, and R3 in that order.
R1—Minimum Wage Compliance: verifies that baseSalary meets or exceeds Germany's minimum wage.
R2—Health Insurance Verification: Checks that the healthInsuranceNumber is provided and valid.
R3—Overtime Compensation Calculation: If baseSalary is low, the rule executor 128 triggers a secondary rule to verify whether overtimeHours sufficiently compensate to meet wage standards.

### Dynamic Adaptation Based on Outcomes:

If Rule R1 fails (i.e., baseSalary does not meet minimum wage), the rule executor 128 dynamically applies additional checks on overtimeHours to see if the overtimeHours make up the shortfall.

If all rules pass, the data proceeds. If any critical check fails, the data is flagged for review and/or an error is raised.

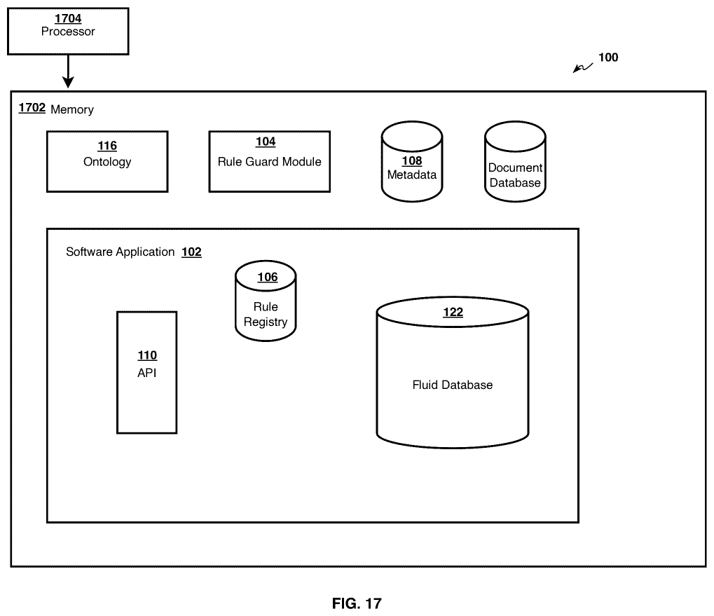

The system 100 may be implemented with additional, different, or fewer components. For example, FIG. 17 illustrates an example of the rule guard system 100 that includes a memory 1702 and a processor 1704.

The processor 1704 may be in communication with the memory 1702. In some examples, the processor 1704 may also be in communication with additional elements, such as a network interface and/or a display. Examples of the processor 1704 may include a general processor, a central processing unit, a microcontroller, a server, an application specific integrated circuit (ASIC), a digital signal processor, a field programmable gate array (FPGA), and/or a digital circuit, an analog circuit.

The processor 1704 may be one or more devices operable to execute logic. The logic may include computer executable instructions or computer code embodied in the memory 1702 or in other memory that, when executed by the processor 1704, cause the processor to perform the features implemented by the logic. The computer code may include instructions executable with the processor 1704.

The memory 1702 may be any device for storing and retrieving data or any combination thereof. The memory 1702 may include non-volatile and/or volatile memory, such as a random-access memory (RAM or DRAM), solid state memory, flash memory, read-only memory (ROM), erasable programmable read-only memory (EPROM), and flash memory. Alternatively, or in addition, the memory 1702 may include an optical, magnetic (hard-drive), or any other form of data storage device.

The system 100 may include more, fewer, or different elements depending on the example. In some examples, the system 100 may also include the software application 102. In another example, the system 100 may include the fluid database 122 and/or the rule registry 106. Similarly, each component may include additional, different, or fewer components than illustrated.

The system 100 may be implemented in many different ways. Each module, such as the rule renderer 124, the rule correlator 126, and the rule executor 128, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 1702, for example, that comprises instructions executable with the processor 1704 or other processor to implement one or more of the features of the module. When any one of the modules includes the portion of the memory that comprises instructions executable with the processor, the module may or may not include the processor. In some examples, each module may just be the portion of the memory 1702 or other physical memory that comprises instructions executable with the processor 1704 or other processor to implement the features of the corresponding module without the module including any other hardware. Because each module includes at least some hardware even when the included hardware comprises software, each module may be interchangeably referred to as a hardware module.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system 100 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library.

The document database 208 may be any type of document database. One such example is the document database provided under the federally registered MONGODB mark.

The fluid database 122 may be any type of database and may include a memory or a portion thereof, such as the memory 1702 shown in FIG. 17, with any electronic collection of information stored therein. The information may be organized so that the information may be accessed, managed, and updated. Examples of a database may include a Structured Query Language (SQL) database, a NoSQL database, a graph database, a Relational Database Management System (RDBMS), an object-oriented database, an extensible markup language (XML) database, a file system, memory structures, or any other organization and storage mechanism. The database may use any type of memory and structure, such as a random-access memory (RAM), a read-only memory (ROM), an erasable programmable read-only memory (EPROM), flash memory, optical memory, magnetic (hard-drive or tape) memory or other memory device.

All of the discussion, regardless of the particular implementation described, is exemplary in nature, rather than limiting. For example, although selected aspects, features, or components of the implementations are depicted as being stored in memories, all or part of the system or systems may be stored on, distributed across, or read from other computer readable storage media, for example, secondary storage devices such as hard disks, flash memory drives, floppy disks, and CD-ROMs. Moreover, the various modules and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer, central processing unit (“CPU”), graphics processing unit (“GPU”), or system.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

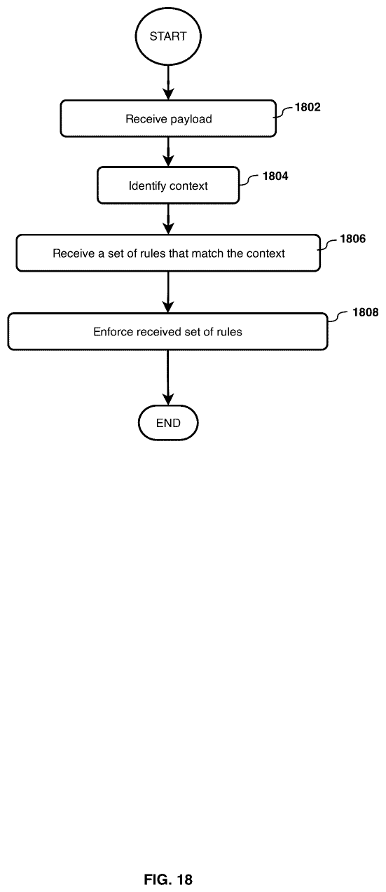

FIG. 18 illustrates an example flow diagram of the logic of the system 100. The operations may include additional, different, or fewer operations. Alterantively, or in addition, the operations may be executed in a different order.

Operations may begin with an operation to receive (1802) the payload 112 comprising data to be written to any of the entities included in an application database schema 120. The application database schema 120 governs storage of the application data 118 in the fluid database 122. The fluid database 122 may be an application database for the software application 102.

A context for the payload 112 may be identified (1804) by identifying, from the payload 112, an entity that is to be updated with the data in the payload and an attribute that identifies a country, a client, or both. The context identifies the entity and the attribute.

A set of rules may be received (1806) that match the context for the payload 112 from the rule registry 106 in which the rules 340 are stored. The rules 340 stored in the rule registry 106 are segregated according to context levels, the context levels including a universal level, a country-specific level, and a client-specific level. Each of the rules 340 stored in the rule registry 106 is associated with a corresponding entity in the application database schema 120. The rules 340 stored in the rule registry 106 include logic executable to enforce the rules 340.

The retrieved set of rules may be enforced (1808) in the payload 112 received, by executing the logic included in the retrieved set of rules.

Operations may end by, for example, returning a code indicating success or failure in enforcing the rules.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action includes setting a Boolean variable to true and the second action is initiated if the Boolean variable is true.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various examples have been described, it will be apparent to those of ordinary skill in the art that many more examples and implementations are possible. Accordingly, the examples and implementations described herein are descriptive, but not the only possible examples and implementations.

The subject-matter of the disclosure may also relate, among others, to the following aspects:

A first aspect relates to a tangible computer readable storage medium comprising computer executable instructions, the computer executable instructions executable by a processor, the computer executable instructions comprising: instructions executable to expose an API (application programming interface) configured to receive a payload and write data included in the payload to any of a plurality of entities included in an application database schema, wherein the application database schema governs storage of application data in a fluid database, wherein the fluid database is an application database for a software application; instructions executable to identify a context for the payload, wherein the context identifies an entity that is to be updated with the data in the payload, the entity included in the entities of the application database schema, and wherein the context includes an attribute identifying a country, a client, or both; instructions executable to search a plurality of rules stored in a rule registry and retrieve a set of rules that match the context for the payload, wherein the rules stored in the rule registry are segregated according to a plurality of context levels, the context levels including a universal level, a country-specific level, and a client-specific level, wherein each of the rules stored in the rule registry is associated with a corresponding entity in the application database schema, wherein the rules stored in the rule registry include logic executable to enforce the rules; and instructions executable to enforce, in the payload received at the API, the retrieved set of rules by execution of the logic included in the retrieved set of rules.

A second aspect relates to the tangible computer readable storage medium of aspect 1, wherein the logic included in the rules stored in the rule registry is multi-layer logic, wherein multi-layer logic means the logic is provided in multiple programming languages to select from.

A third aspect relates to the tangible computer readable storage medium of aspect 2 further comprising instructions executable to select, in the execution of the logic included in the retrieved set of rules, the logic in a language applicable to an application layer.

A fourth aspect relates to the tangible computer readable storage medium of any preceding aspect further comprising instructions executable to apply a priority hierarchy in response to the retrieved set of rules including multiple rules, wherein in the priority hierarchy, country-specific rules take precedence over universal rules, and client-specific rules take precedence over country-specific rules.

A fifth aspect relates to the tangible computer readable storage medium of any preceding aspect, wherein the rules stored in the rule registry are further segregated according to constituents, wherein the context for the payload further identifies a constituent, and wherein the retrieved set of rules matches the context, which identifies the constituent, the entity, as well as the country, the client, or both.

A sixth aspect relates to the tangible computer readable storage medium of any preceding aspect, wherein the rules stored in the rule registry are further segregated according to layers, wherein the context for the payload further identifies a layer, and wherein the retrieved set of rules matches the context, which identifies the layer, the entity, as well as the country, the client, or both.

A seventh aspect relates to the tangible computer readable storage medium of any preceding aspect further comprising instructions executable to enforce inheritance relationships identified in the rules stored in the rule registry.

An eighth aspect relates to a rule guard system comprising: a processor; a rule execution validation module executable by the processor to receive a payload and write data included in the payload to any of a plurality of entities included in an application database schema, wherein the application database schema governs storage of application data in a fluid database, wherein the fluid database is an application database for a software application, wherein rule execution validation module executable is further identify a context for the payload, wherein the context identifies an entity that is to be updated with the data in the payload, the entity included in the entities of the application database schema, and wherein the context includes an attribute identifying a country, a client, or both; a hierarchical rule retrieval module executable by the processor to search a plurality of rules stored in a rule registry and retrieve a set of rules that match the context for the payload, wherein the rules stored in the rule registry are segregated according to a plurality of context levels, the context levels including a universal level, a country-specific level, and a client-specific level, wherein each of the rules stored in the rule registry is associated with a corresponding entity in the application database schema, wherein the rules stored in the rule registry include logic executable to enforce the rules; and an execution module executable by the processor to enforce, in the payload received at the API, the retrieved set of rules by execution of the logic included in the retrieved set of rules.

A ninth aspect relates to the rule guard system of aspect 8, wherein the rule execution validation module is further executable by the processor to identify a field having incoming data in the payload, wherein the field belongs to the entity, and wherein the set of rules that match the context are limited to any of the rules relevant to the field of the entity.

A tenth aspect relates to the rule guard system of any proceding aspect further comprising a dynamic constraint selection module executable by the processor to limit the retrieved set of rules to those applicable to a source of the payload.

A eleventh aspect relates to the rule guard system of any proceding aspect, wherein the execution module is further executable by the processor to verify a structural integrity of the payload via execution of any of the retrieved set of rules that is decorated with a SHACL shape.

A twelfth aspect relates to the rule guard system of any proceding aspect, wherein the logic included in the rules stored in the rule registry is multi-layer logic, wherein multi-layer logic means the logic is provided in multiple programming languages to select from.

A thirteenth aspect relates to the rule guard system of aspect 12, wherein the execution module is further executable by the processor to select, in the execution of the logic included in the retrieved set of rules, the logic in a language applicable to an application layer.

A fourteenth aspect relates to the rule guard system of any proceding aspect, wherein the hierarchical rule retrieval module is further executable by the processor to apply a priority hierarchy in response to the retrieved set of rules including multiple rules, wherein in the priority hierarchy, country-specific rules take precedence over universal rules, and client-specific rules take precedence over country-specific rules.

A fifteenth aspect relates to a computer-implemented method comprising: receiving a payload comprising data to be written to any of a plurality of entities included in an application database schema, wherein the application database schema governs storage of application data in a fluid database, wherein the fluid database is an application database for a software application; identifying a context for the payload by identifying, from the payload, an entity that is to be updated with the data in the payload and an attribute that identifies a country, a client, or both, wherein the entity is included in the entities of the application database schema, and wherein the context identifies the entity and the attribute; retrieving a set of rules that match the context for the payload from a rule registry in which a plurality of rules are stored, wherein the rules stored in the rule registry are segregated according to a plurality of context levels, the context levels including a universal level, a country-specific level, and a client-specific level, wherein each of the rules stored in the rule registry is associated with a corresponding entity in the application database schema, wherein the rules stored in the rule registry include logic executable to enforce the rules; and enforcing, in the payload, the retrieved set of rules by executing the logic included in the retrieved set of rules.

A sixteenth aspect relates to the method of aspect 15, wherein the logic to enforce each respective rule of the rules is included in the respective rule in multiple programming languages.

A seventeenth aspect relates to the method of aspect 16 further comprising selecting, to enforce the retrieved set of rules, the logic that is in a language applicable to an application layer from which the payload originated.

An eighteenth aspect relates to the method of any proceding aspect further comprising assembling a plurality of SHACL shapes specific to a domain and the country from the retrieved set of rules, wherein enforcing the retrieved set of rules comprises executing the SHACL shapes.

A nineteenth aspect relates to the method of any proceding aspect, wherein executing the SHACL shapes enforces a relationship between fields and constraints.

A twentieth aspect relates to the method of any proceding aspect further comprising applying a priority hierarchy in response to the retrieved set of rules including multiple rules, wherein in the priority hierarchy, country-specific rules take precedence over universal rules, and client-specific rules take precedence over country-specific rules.

In addition to the features mentioned in each of the independent aspects enumerated above, some examples may show, alone or in combination, the optional features mentioned in the dependent aspects and/or as disclosed in the description above and shown in the figures.

What is claimed is:

1. A tangible computer readable storage medium comprising computer executable instructions, the computer executable instructions executable by a processor, the computer executable instructions comprising:
instructions executable to expose an API (application programming interface) configured to receive a payload and write data included in the payload to any of a plurality of entities included in an application database schema, wherein the application database schema governs storage of application data in a fluid database, wherein the fluid database is an application database for a software application;
instructions executable to identify a context for the payload, wherein the context identifies an entity that is to be updated with the data in the payload, the entity included in the entities of the application database schema, and wherein the context includes an attribute identifying a country, a client, or both;
instructions executable to search a plurality of rules stored in a rule registry and retrieve a set of rules that match the context for the payload, wherein the rules stored in the rule registry are segregated according to a plurality of context levels, the context levels including a universal level, a country-specific level, and a client-specific level, wherein each of the rules stored in the rule registry is associated with a corresponding entity in the application database schema, wherein the rules stored in the rule registry include logic executable to enforce the rules; and
instructions executable to enforce, in the payload received at the API, the retrieved set of rules by execution of the logic included in the retrieved set of rules.

2. The tangible computer readable storage medium of claim 1, wherein the logic included in the rules stored in the rule registry is multi-layer logic, wherein multi-layer logic means the logic is provided in multiple programming languages to select from.

3. The tangible computer readable storage medium of claim 2 further comprising instructions executable to select, in the execution of the logic included in the retrieved set of rules, the logic in a language applicable to an application layer.

4. The tangible computer readable storage medium of claim 1 further comprising instructions executable to apply a priority hierarchy in response to the retrieved set of rules including multiple rules, wherein in the priority hierarchy, country-specific rules take precedence over universal rules, and client-specific rules take precedence over country-specific rules.

5. The tangible computer readable storage medium of claim 1, wherein the rules stored in the rule registry are further segregated according to constituents, wherein the context for the payload further identifies a constituent, and wherein the retrieved set of rules matches the context, which identifies the constituent, the entity, as well as the country, the client, or both.

6. The tangible computer readable storage medium of claim 1, wherein the rules stored in the rule registry are further segregated according to layers, wherein the context for the payload further identifies a layer, and wherein the retrieved set of rules matches the context, which identifies the layer, the entity, as well as the country, the client, or both.

7. The tangible computer readable storage medium of claim 1 further comprising instructions executable to enforce inheritance relationships identified in the rules stored in the rule registry.

8. A rule guard system comprising:
a processor;
a rule execution validation module executable by the processor to receive a payload and write data included in the payload to any of a plurality of entities included in an application database schema, wherein the application database schema governs storage of application data in a fluid database, wherein the fluid database is an application database for a software application,
wherein rule execution validation module executable is further identify a context for the payload, wherein the context identifies an entity that is to be updated with the data in the payload, the entity included in the entities of the application database schema, and wherein the context includes an attribute identifying a country, a client, or both;
a hierarchical rule retrieval module executable by the processor to search a plurality of rules stored in a rule registry and retrieve a set of rules that match the context for the payload, wherein the rules stored in the rule registry are segregated according to a plurality of context levels, the context levels including a universal level, a country-specific level, and a client-specific level, wherein each of the rules stored in the rule registry is associated with a corresponding entity in the application database schema, wherein the rules stored in the rule registry include logic executable to enforce the rules; and
an execution module executable by the processor to enforce, in the payload, the retrieved set of rules by execution of the logic included in the retrieved set of rules.

9. The rule guard system of claim 8, wherein the rule execution validation module is further executable by the processor to identify a field having incoming data in the payload, wherein the field belongs to the entity, and wherein the set of rules that match the context are limited to any of the rules relevant to the field of the entity.

10. The rule guard system of claim 8 further comprising a dynamic constraint selection module executable by the processor to limit the retrieved set of rules to those applicable to a source of the payload.

11. The rule guard system of claim 8, wherein the execution module is further executable by the processor to verify a structural integrity of the payload via execution of any of the retrieved set of rules that is decorated with a SHACL shape.

12. The rule guard system of claim 8, wherein the logic included in the rules stored in the rule registry is multi-layer logic, wherein multi-layer logic means the logic is provided in multiple programming languages to select from.

13. The rule guard system of claim 12, wherein the execution module is further executable by the processor to select, in the execution of the logic included in the retrieved set of rules, the logic in a language applicable to an application layer.

14. The rule guard system of claim 8, wherein the hierarchical rule retrieval module is further executable by the processor to apply a priority hierarchy in response to the retrieved set of rules including multiple rules, wherein in the priority hierarchy, country-specific rules take precedence over universal rules, and client-specific rules take precedence over country-specific rules.

15. A computer-implemented method comprising:
receiving a payload comprising data to be written to any of a plurality of entities included in an application database schema, wherein the application database schema governs storage of application data in a fluid database, wherein the fluid database is an application database for a software application;
identifying a context for the payload by identifying, from the payload, an entity that is to be updated with the data in the payload and an attribute that identifies a country, a client, or both, wherein the entity is included in the entities of the application database schema, and wherein the context identifies the entity and the attribute;
retrieving a set of rules that match the context for the payload from a rule registry in which a plurality of rules are stored, wherein the rules stored in the rule registry are segregated according to a plurality of context levels, the context levels including a universal level, a country-specific level, and a client-specific level, wherein each of the rules stored in the rule registry is associated with a corresponding entity in the application database schema, wherein the rules stored in the rule registry include logic executable to enforce the rules; and
enforcing, in the payload received, the retrieved set of rules by executing the logic included in the retrieved set of rules.

16. The method of claim 15, wherein the logic to enforce each respective rule of the rules is included in the respective rule in multiple programming languages.

17. The method of claim 16 further comprising selecting, to enforce the retrieved set of rules, the logic that is in a language applicable to an application layer from which the payload originated.

18. The method of claim 15 further comprising assembling a plurality of SHACL shapes specific to a domain and the country from the retrieved set of rules, wherein enforcing the retrieved set of rules comprises executing the SHACL shapes.

19. The method of claim 15, wherein executing the SHACL shapes enforces a relationship between fields and constraints.

20. The method of claim 15 further comprising applying a priority hierarchy in response to the retrieved set of rules including multiple rules, wherein in the priority hierarchy, country-specific rules take precedence over universal rules, and client-specific rules take precedence over country-specific rules.
